(19) United States
(12) Patent Application Publication
(10) Pub. No.: US 2025/0075534 A1
(43) Pub. Date: Mar. 6, 2025

(54) LOCK DEVICE

(71) Applicants: Gregory Boylan Waugh, Stevenson Ranch, CA (US); David Larry Freiberg, Valencia, CA (US)

(72) Inventors: Gregory Boylan Waugh, Stevenson Ranch, CA (US); David Larry Freiberg, Valencia, CA (US)

(21) Appl. No.: 18/456,710

(22) Filed: Aug. 28, 2023

(51) Int. Cl. E05B 65/52

(52) U.S. Cl. CPC E05B 65/5246

(57) ABSTRACT

A lock device that has a striker member and a protective lock casing. The protective casing houses a cylinder assembly and a rotary latch. The rotary latch is actuated from a latched position to an unlatched position for unlocking the lock device, and is actuated from an unlatched position to a latched position by the striker member when engaged with the rotary latch for locking the lock device.

### CROSS-REFERENCE TO RELATED APPLICATIONS

All documents mentioned in this specification are herein incorporated by reference to the same extent as if each individual document was specifically and individually indicated to be incorporated by reference.

It should be noted that throughout the disclosure, where a definition or use of a term in any incorporated document(s) is inconsistent or contrary to the definition of that term provided herein, the definition of that term provided herein applies and the definition of that term in the incorporated document(s) does not apply.

### BACKGROUND OF THE INVENTION

### Field of the Invention

One or more embodiments of the present invention relate to a lock device and more particularly, to a lock device that houses a rotary latch mechanism.

### Description of Related Art

Conventional lock devices used for securely locking containers such as a truck tool box are well known and have been in use for a number of years.

Regrettably, most conventional lock systems used for securing truck tool boxes are highly specialized lock systems, requiring large number of complex components and a specialized skill-set such as welding, etc. to assemble and securely mount the lock systems on the truck tool boxes.

As importantly, most conventional lock systems used for securing truck tool boxes are mounted internally, inside the truck tool box so as to not be exposed to tampering. The drawback to internally installed lock systems is that precious storage space in the container is used by the lock systems for securing the container. This leaves less storage space for storing tools.

Another drawback to internally installed lock systems is that as a vehicle moves, the loose tools inside the container may move and potentially become wedged with one or more components of the internal lock system, seizing up or jamming the lock.

If a container does have an external hasp or clasp, then the use of conventional external locks such as padlocks, etc., would be possible to use to lock the container. However, existing external lock systems (padlocks) would require removal of the padlock for opening the container, storing the removed padlock in a secure place so that it is not lost prior to removing the desired object from the container, and as importantly, immediately relocking the container with the padlock every single time the desired object is removed. If a user forgets an object still in the container, the entire process must be repeated.

Accordingly, in light of the current state of the art and the drawbacks to current lock systems mentioned above, a need exists for a lock device for a container that would be simple to manufacture, and be retrofitted external to the container with ease without requiring specialized skill set.

Further, a need exists for a lock device for a container that would be installed external to the container but without requiring the removal of the lock to open the container, while allowing the lid of the container to automatically lock when closed.

Further, a need exists for a lock device for a container that would be installed external to the container that would be encapsulated and shielded within a protective casing to ward off tampering with the lock device.

### BRIEF SUMMARY OF THE INVENTION

A non-limiting, exemplary aspect of an embodiment of the present invention provides a lock device for a container, comprising:
a striker member fixed external a lid of the container;
a protective lock casing fixed external the container;
the protective lock casing houses:
a cylinder assembly; and
a rotary latch;
the rotary latch is actuated from a latched position to an unlatched position for unlocking the lock device, and is actuated from an unlatched position to a latched position by the striker member when engaged with the rotary latch for locking the lock device.

Another non-limiting, exemplary aspect of an embodiment of the present invention provides a lock device, comprising:
a striker member;
a protective lock casing that houses:
a cylinder assembly; and
a rotary latch;
the rotary latch is actuated from a latched position to an unlatched position for unlocking the lock device, and is actuated from an unlatched position to a latched position by the striker member when engaged with the rotary latch for locking the lock device.

Still another non-limiting, exemplary aspect of an embodiment of the present invention provides a lock device for a truck tool box, comprising:
a striker member fixed external a lid of the truck tool box;
a protective lock casing fixed external the truck tool box;
the protective lock casing houses:
a cylinder assembly; and
a rotary latch;
the rotary latch is actuated from a latched position to an unlatched position for unlocking the lock device, and is actuated from an unlatched position to a latched position by the striker member when engaged with the rotary latch for locking the lock device.

These and other features and aspects of the invention will be apparent to those skilled in the art from the following detailed description of preferred non-limiting exemplary embodiments, taken together with the drawings and the claims that follow.

### BRIEF DESCRIPTION OF THE DRAWINGS

It is to be understood that the drawings are to be used for the purposes of exemplary illustration only and not as a definition of the limits of the invention. Throughout the disclosure, the word “exemplary” may be used to mean “serving as an example, instance, or illustration,” but the absence of the term “exemplary” does not denote a limiting embodiment. Any embodiment described as “exemplary” is not necessarily to be construed as preferred or advantageous over other embodiments. In the drawings, like reference character(s) present corresponding part(s) throughout.

FIGS. 1A to 1F are non-limiting, exemplary illustrations of a lock device mounted on a container (e.g., a truck tool box), progressively illustrating a non-limiting, exemplary method of using the lock device in accordance with one or more embodiments of the present invention;

FIGS. 2A to 2F are non-limiting, exemplary illustrations of the lock device mounted on the container (e.g., a truck tool box), as shown in FIGS. 1A to 1F, illustrating a method of mounting the same to the container in accordance with one or more embodiments of the present invention;

FIGS. 3A to 3N are non-limiting exemplary exploded view illustrations of the various components of lock device shown in FIGS. 1A to 2F in accordance with one or more embodiments of the present invention;

FIGS. 4A to 4G are non-limiting exemplary illustrations of the various views of a striker member of the lock device shown in FIGS. 1A to 3N in accordance with one or more embodiments of the present invention;

FIGS. 5A to 5M are non-limiting exemplary illustrations of the various views of a cylinder assembly of the lock device shown in FIGS. 1A to 4G in accordance with one or more embodiments of the present invention;

FIGS. 6A to 6I are non-limiting exemplary illustrations of the various views of a rotary latch of the lock device shown in FIGS. 1A to 5M in accordance with one or more embodiments of the present invention;

FIGS. 7A to 7F are non-limiting exemplary illustrations of the various views of a protective lock casing of the lock device shown in FIGS. 1A to 6I in accordance with one or more embodiments of the present invention; and

FIGS. 8A to 8L are non-limiting exemplary illustrations of the various views of the exposed parts of the lock device shown in FIGS. 1A to 7F, progressively illustrating a non-limiting, exemplary method of operation of the lock device components in accordance with one or more embodiments of the present invention.

### DETAILED DESCRIPTION OF THE INVENTION

The detailed description set forth below in connection with the appended drawings is intended as a description of presently preferred embodiments of the invention and is not intended to represent the only forms in which the present invention may be constructed and or utilized.

It is to be appreciated that certain features of the invention, which are, for clarity, described in the context of separate embodiments, may also be provided in combination in a single embodiment. Conversely, various features of the invention that are, for brevity, described in the context of a single embodiment may also be provided separately or in any suitable sub-combination or as suitable in any other described embodiment of the invention. Stated otherwise, although the invention is described below in terms of various exemplary embodiments and implementations, it should be understood that the various features and aspects described in one or more of the individual embodiments are not limited in their applicability to the particular embodiment with which they are described, but instead can be applied, alone or in various combinations, to one or more of the other embodiments of the invention.

One or more embodiments of the present invention provide a lock device for a container (e.g., a truck tool box) that is simple to manufacture, and is quickly retrofitted external to the container with ease without requiring specialized skill set.

Further, one or more embodiments of the present invention provide a lock device for a container that is installed external to the container but without requiring the removal of the lock to open the container, while allowing the lid of the container to automatically lock when closed.

Further, one or more embodiments of the present invention provide a lock device for a container that is installed external to the container that is encapsulated and shielded within a protective casing to ward off tampering with the lock device.

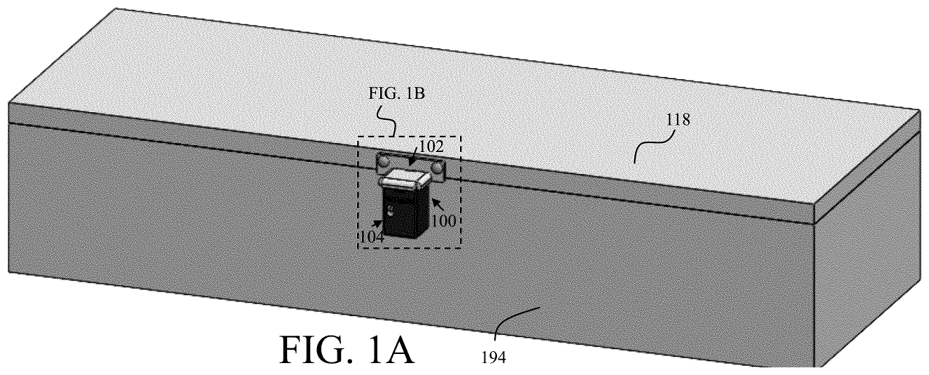

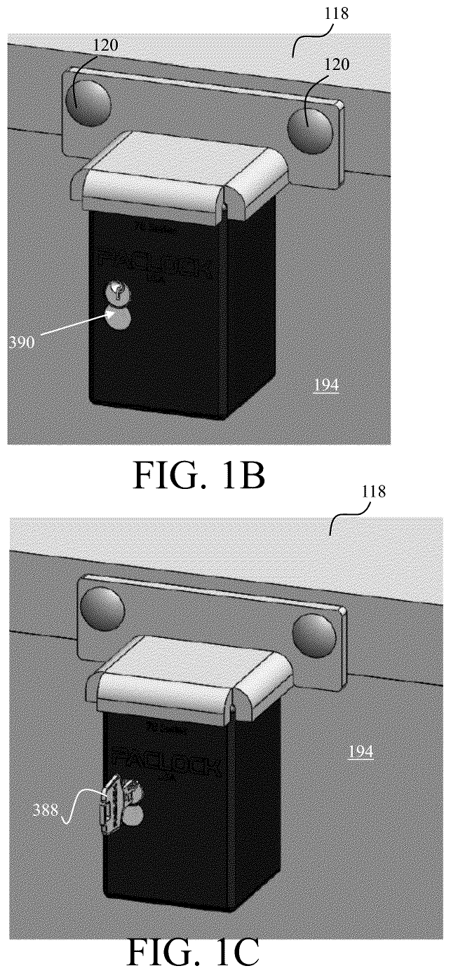

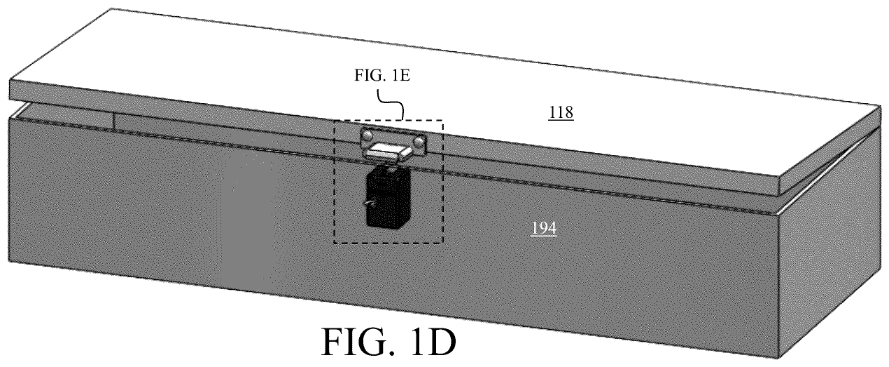

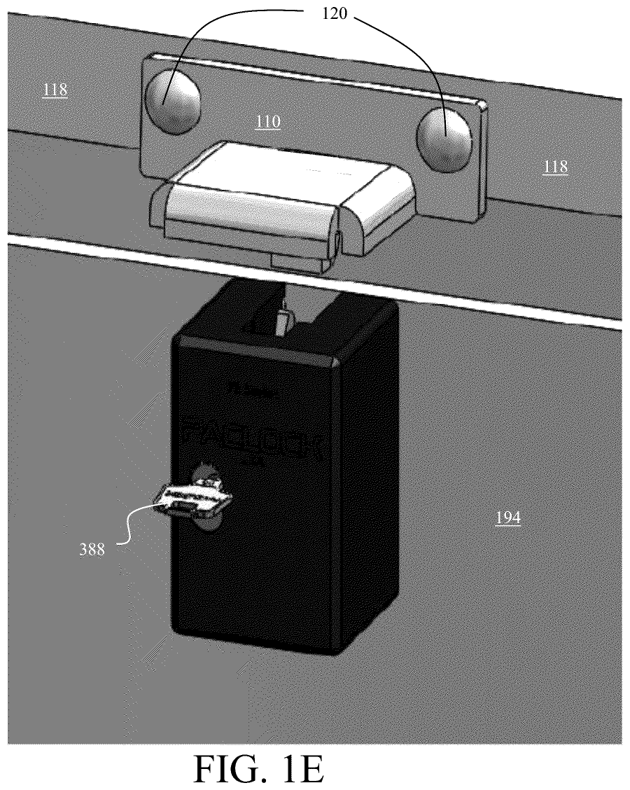

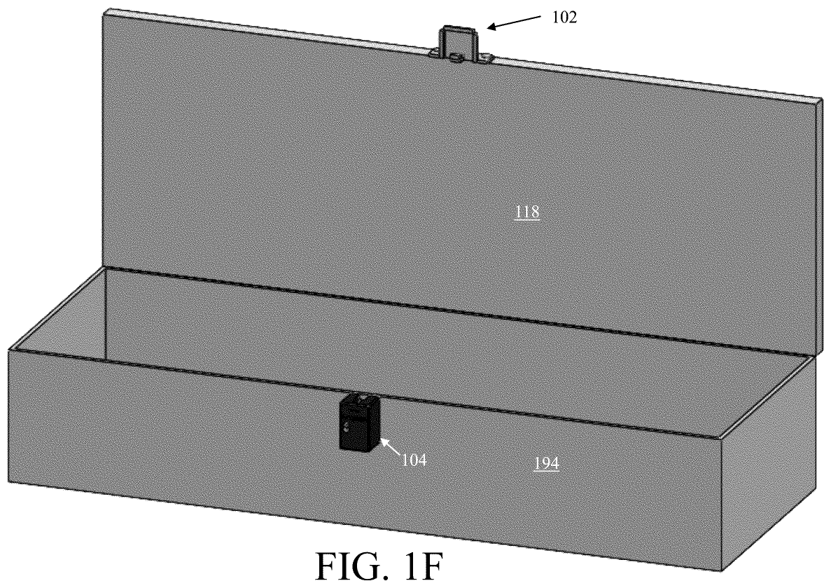

FIGS. 1A to 1F are non-limiting, exemplary illustrations of a lock device mounted on a container (e.g., a truck tool box), progressively illustrating a non-limiting, exemplary method of using the lock device in accordance with one or more embodiments of the present invention.

As illustrated in FIGS. 1A to 1F, to open a lid 118 of a truck tool box 194 lock device 100 users simply insert a key 388 into a conventional key cylinder 390 with one hand and upon turning of the key 388, the lid 118 simply unlocks and pops open. Thereafter, the key 388 may be removed while the lid 118 remains open for allowing access to the truck tool box 194. To relock the truck tool box 194, the users simply close the lid 118 and the truck tool box 194 relocks.

Lock device 100 installed external to the container does not require the removal of the lock to open the container, while allowing the lid of the container to automatically lock when closed. Further, the lock device is encapsulated and shielded within a protective casing 104 to ward off tampering with the lock device.

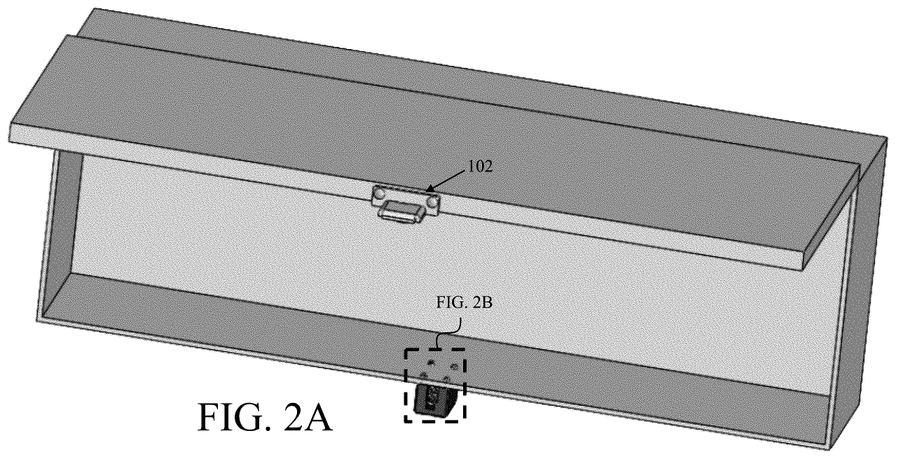

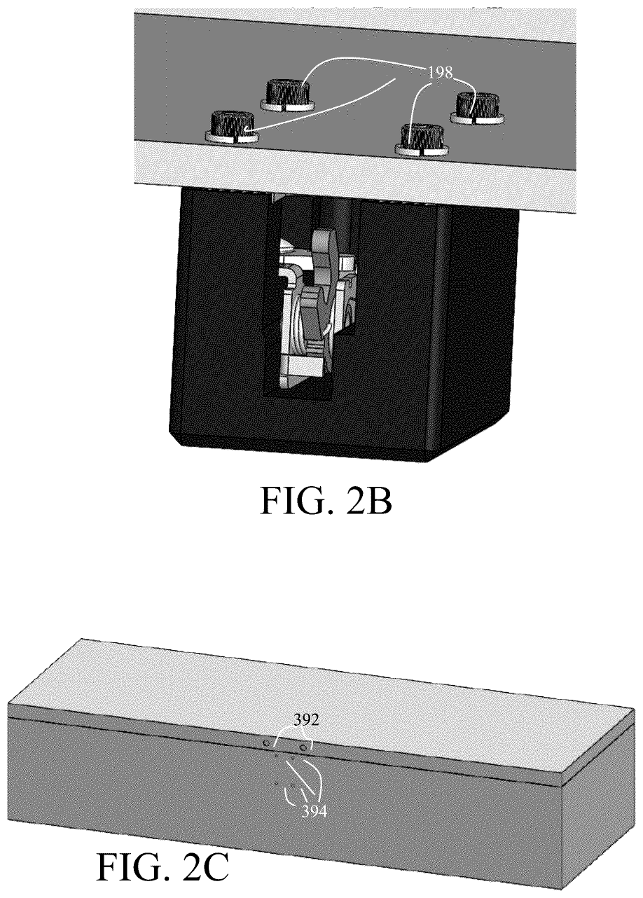

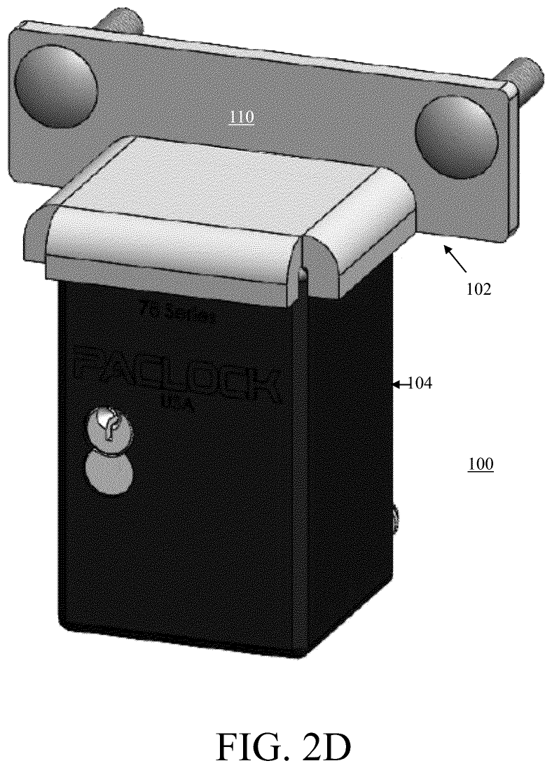

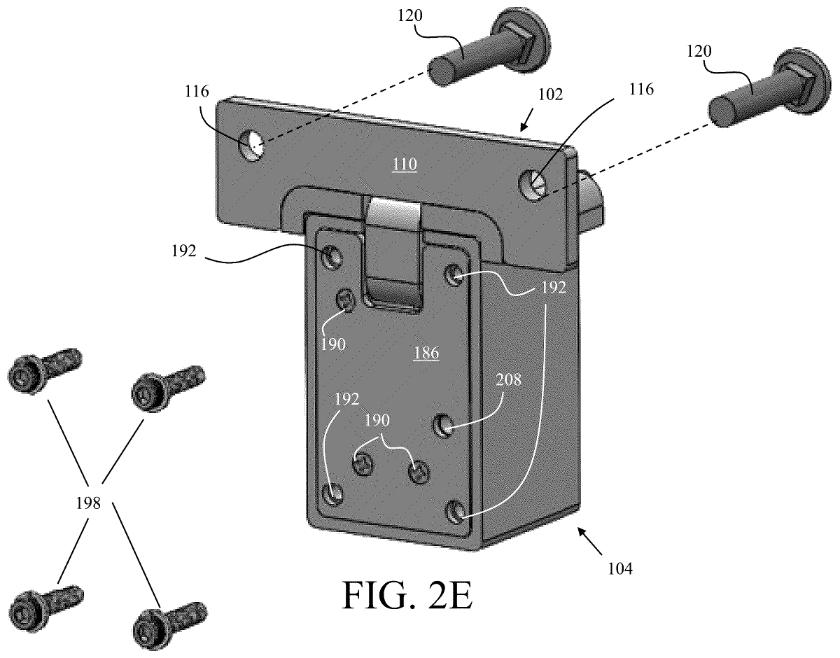

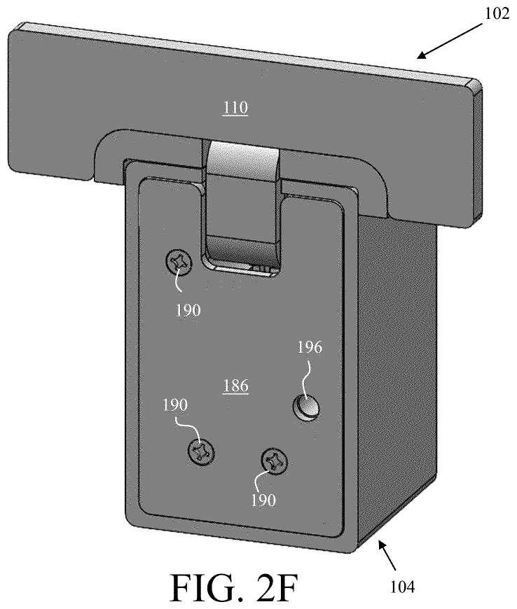

FIGS. 2A to 2F are non-limiting, exemplary illustrations of the lock device mounted on the container (e.g., a truck tool box), as shown in FIGS. 1A to 1F, illustrating a method of mounting the same to the container in accordance with one or more embodiments of the present invention.

As illustrated in FIGS. 1A to 2F, lock device 100 may be quickly retrofitted external to container 194 with ease without requiring specialized skill set—only two sets of fasteners 120 and 198.

Fasteners 120 may be used to secure and fix striker member 102 of lock device 100 external to lid 118 (via lid openings 392 and striker openings 116). Fasteners 198 may be used to secure and fix protective lock casing 104 of lock device 100 external to container 194 (via container openings 394 and openings 192 of rear protective enclosure 186).

Optionally, both striker member 102 and protective lock casing 104 may be welded to respective lid 118 and container 194 in well known conventional manner with no use of fasteners as shown in FIG. 2F and hence, no need for openings 116 or 192.

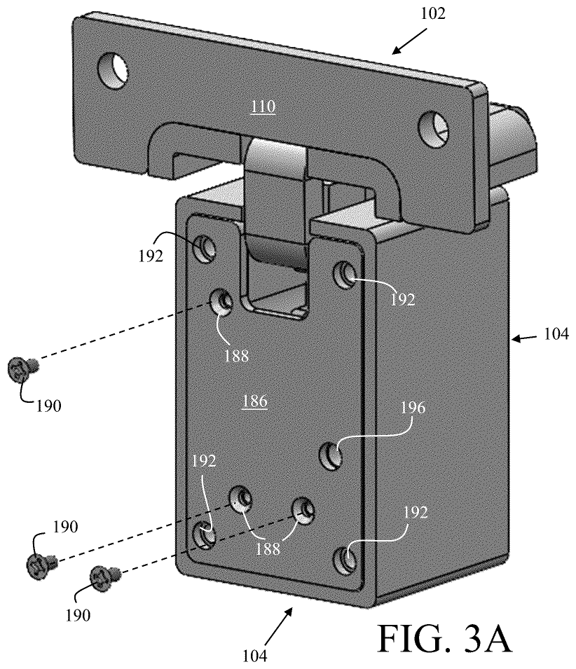

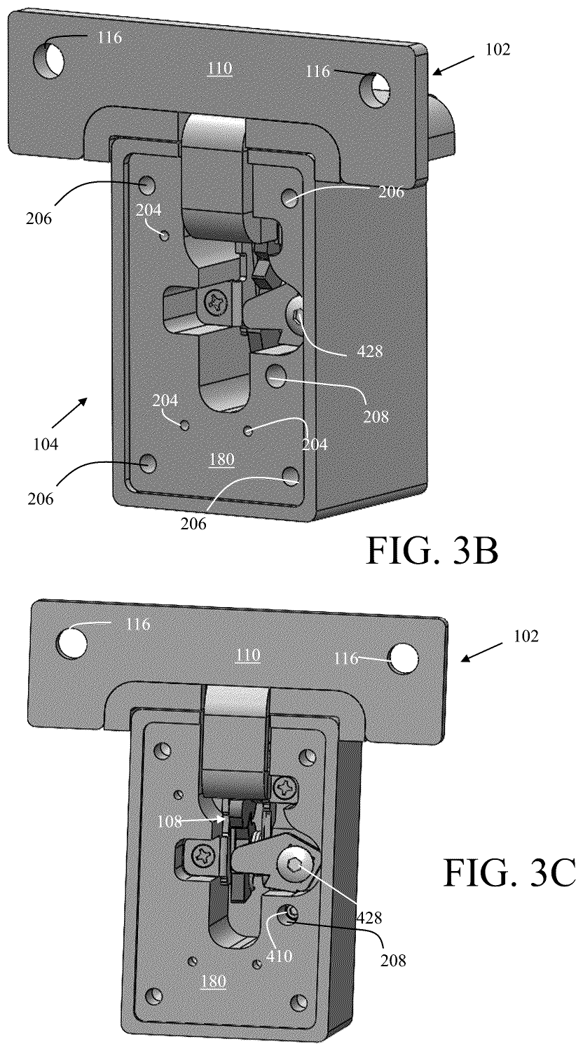

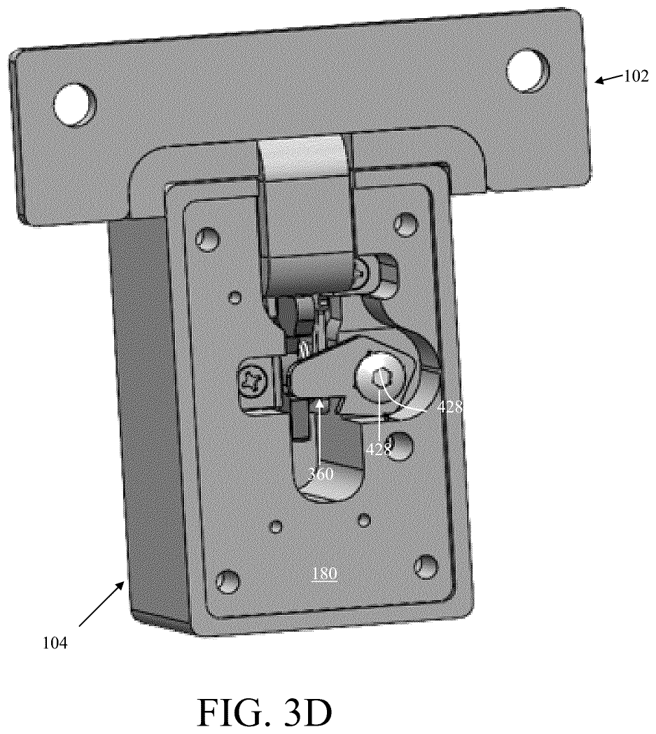

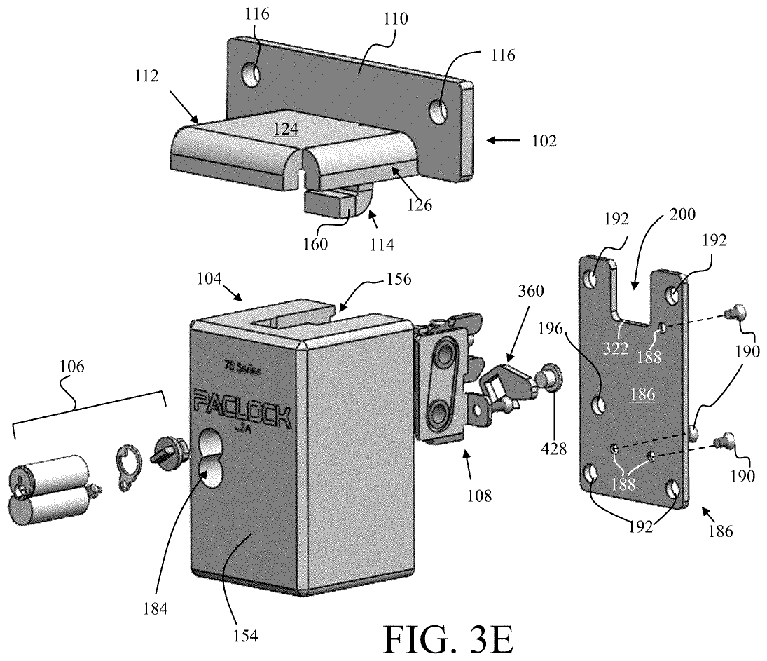

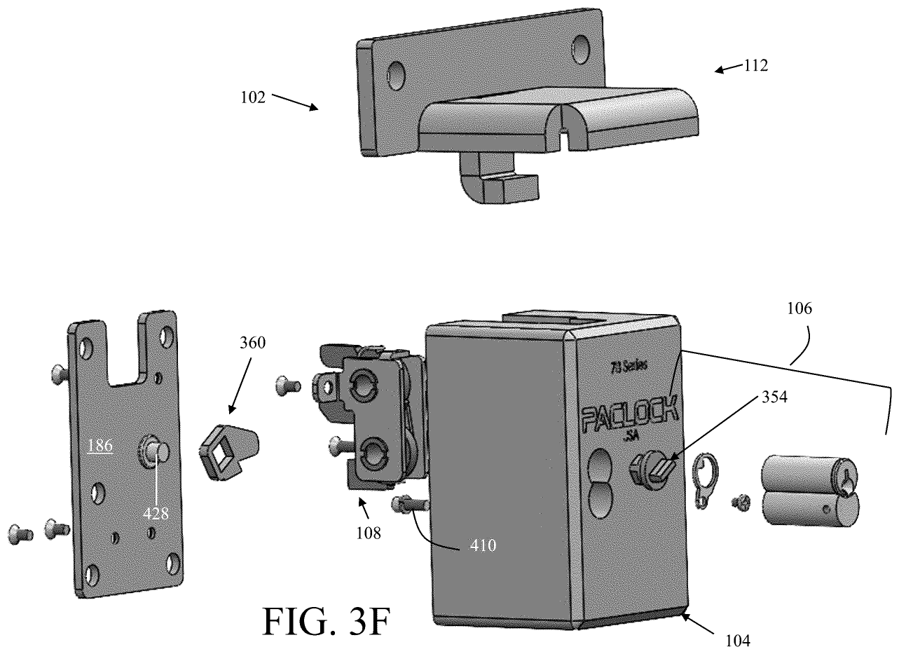

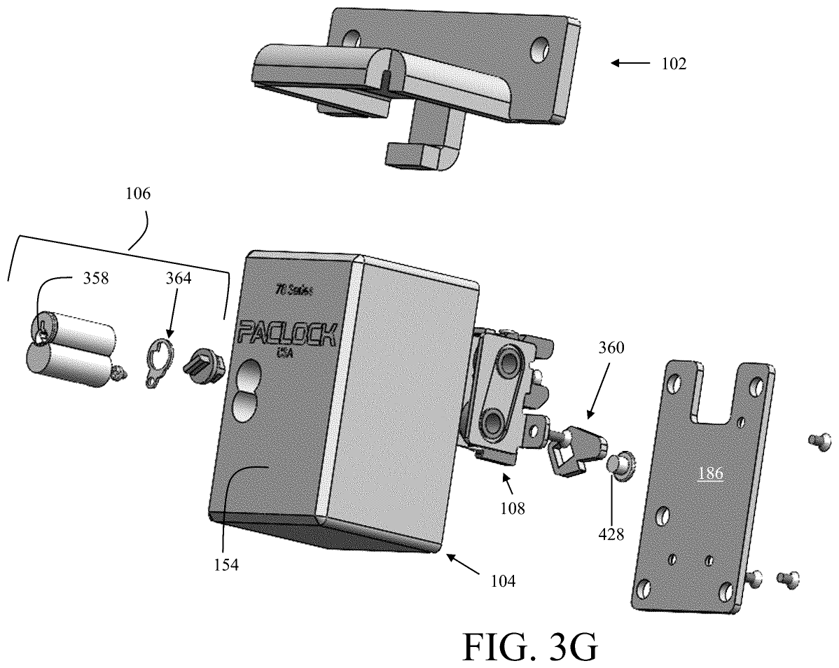

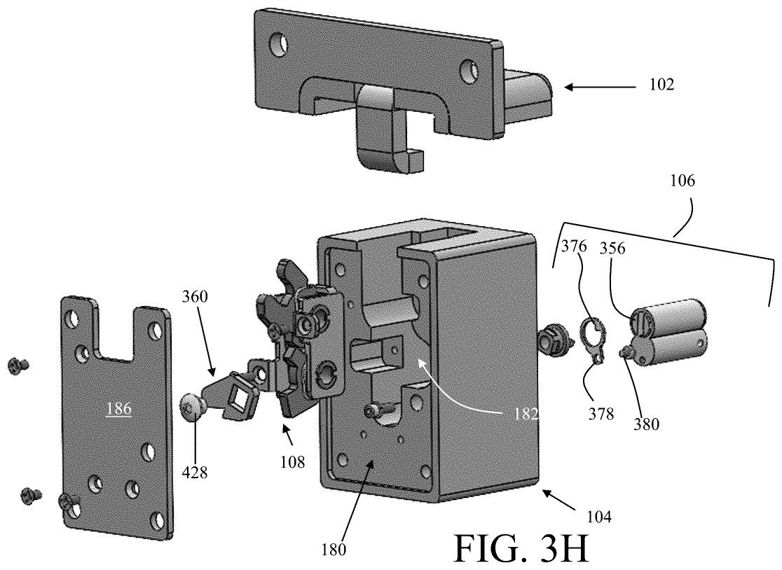

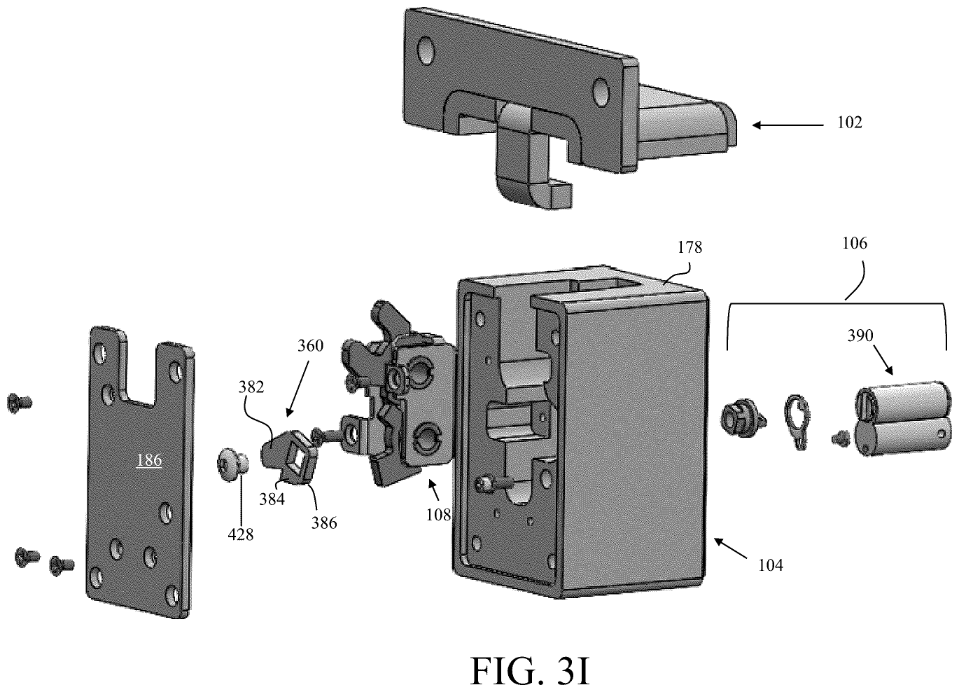

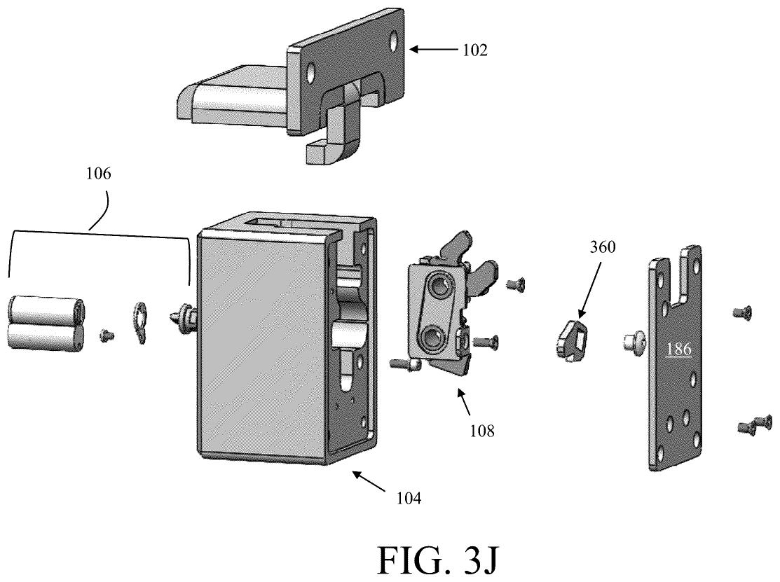

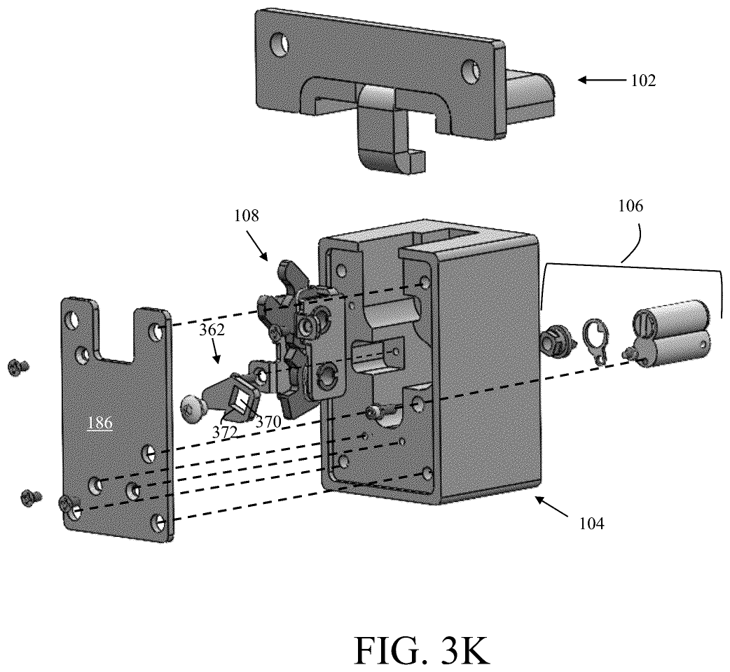

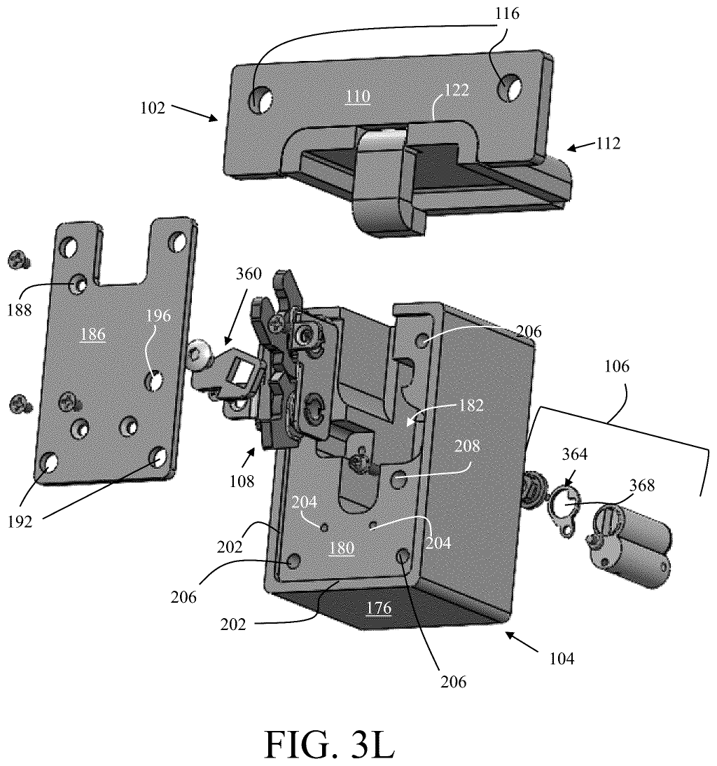

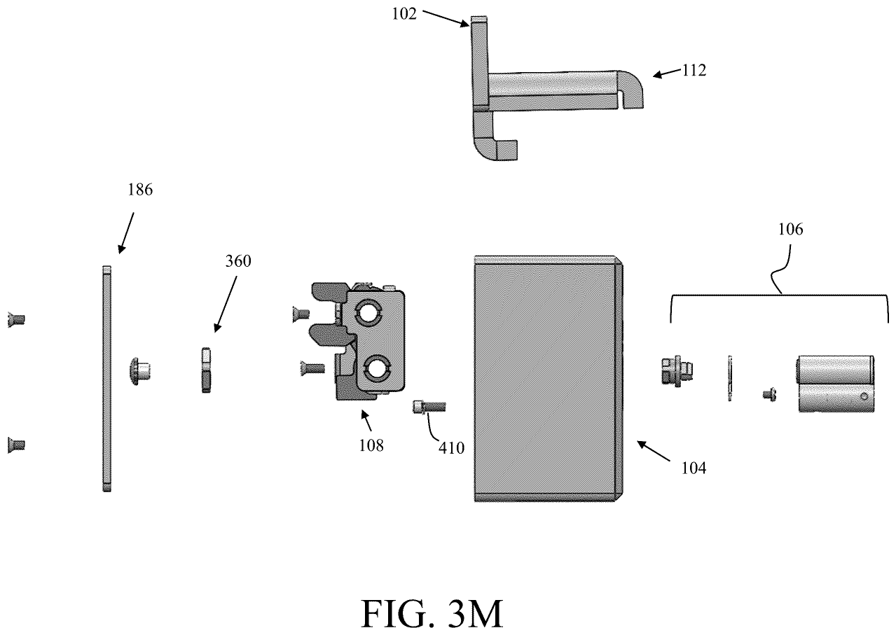

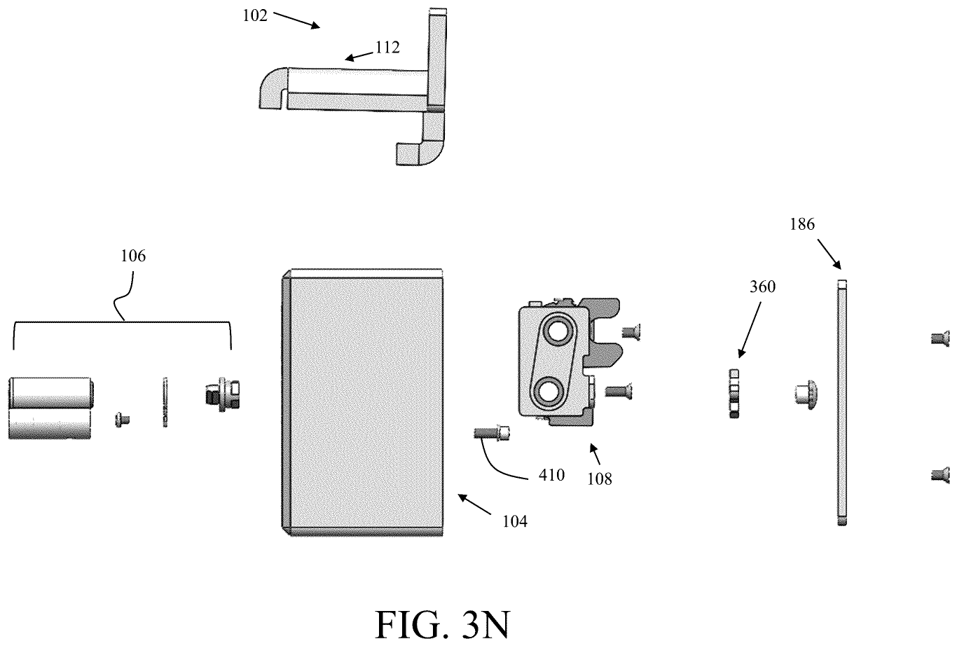

FIGS. 3A to 3N are non-limiting exemplary exploded view illustrations of the various components of lock device shown in FIGS. 1A to 2F in accordance with one or more embodiments of the present invention.

The exploded views shown in FIG. 3A to 3N illustrate disassembled, separated components that show the cooperative working relationship, orientation, positioning, and exemplary manner of assembly of the various components of lock device 100 in accordance with one or more embodiments of the present invention, with each component detailed below.

As illustrated in FIGS. 1A to 3N, lock device 100 may be comprised of striker member 102 and protective lock casing 104. Protective lock casing 104 securely houses a cylinder assembly 106 and a rotary latch 108.

As best shown in FIGS. 2E to 3N, further included is a rear protective enclosure (or plate) 186 that has a first set of openings 188 to secure rear protective enclosure 186 to the protective casing 104 using fasteners 190. Further included are a second set of openings 192 to secure the protective casing 104 of the lock device 100 to an exterior side of a container 194 using fasteners 198. Rear protective enclosure 186 also includes one or more third openings 196 to secure one or more components of the lock device 100 within the protective casing 104. A relief 200 is also provided for accommodating striker 114 when in fully locked position.

As further detailed below, rotary latch 108 is actuated from a latched position (FIGS. 1A to 1C) to an unlatched position (FIGS. 1D to 1F) for unlocking lock device 100, and is actuated from an unlatched position to a latched position by striker member 102 when engaged with rotary latch 108 for locking lock device 100.

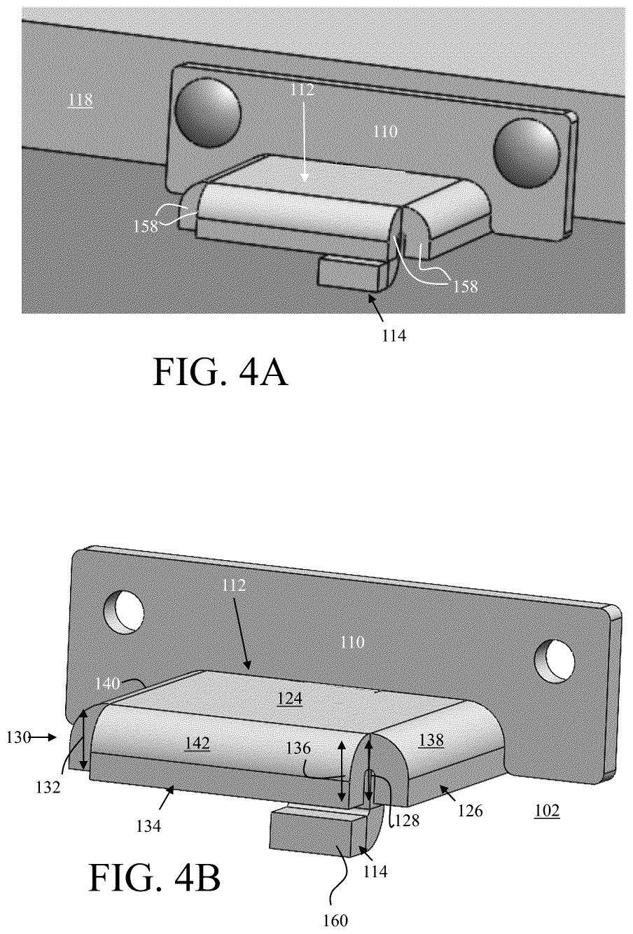

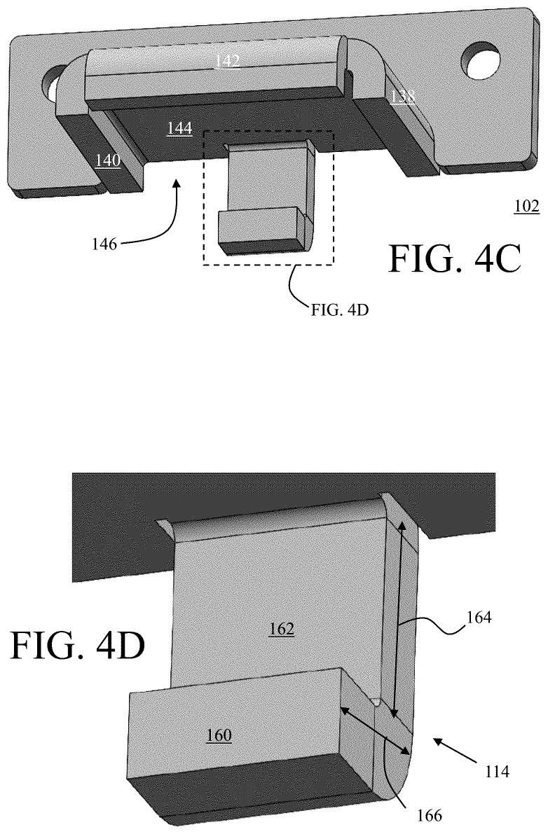

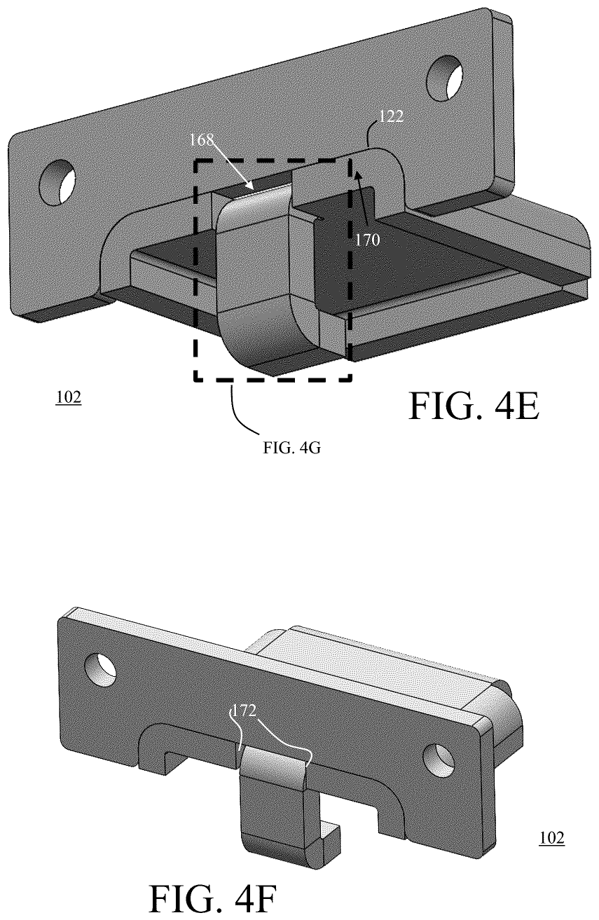

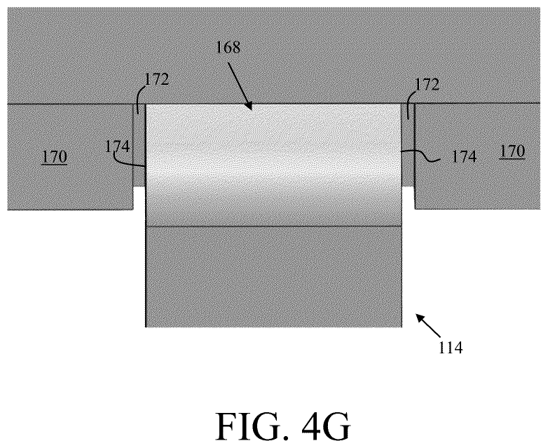

FIGS. 4A to 4G are non-limiting exemplary illustrations of the various views of a striker member of the lock device shown in FIGS. 1A to 3N in accordance with one or more embodiments of the present invention. As illustrated in FIGS. 1A to 4G, striker member 102 may be comprised of a single piece unit, having an attachment plate 110, a protective shroud cover 112, and a striker 114.

Attachment plate 110 may be comprised of a first and a second opening 116 to fix attachment plate 110 onto an exterior side lid 118 using fasteners 120. As indicated above, attachment plate 110 may optionally be welded to lid 118 instead. Attachment plate 110 also includes a relief 122 for accommodating protective shroud cover 112.

Protective shroud cover 112 of striker member 102 may be comprised of a main cover 124. Protective shroud cover 112 may further include a first lateral projection 126 that extends perpendicular to a plane of main cover 124 from a first lateral side of the main cover 124 at a first height 128 to form a first shroud 138.

Protective shroud cover 112 may further include a second lateral projection 130 that extends perpendicular to the plane of the main cover 124 from a second lateral side of the main cover 124 at a second height 132 to form a second shroud 140.

Protective shroud cover 112 may further include a front projection 134 that extends perpendicular to the plane of the main cover 124 from the front side at a third height 136 to form a third shroud 142.

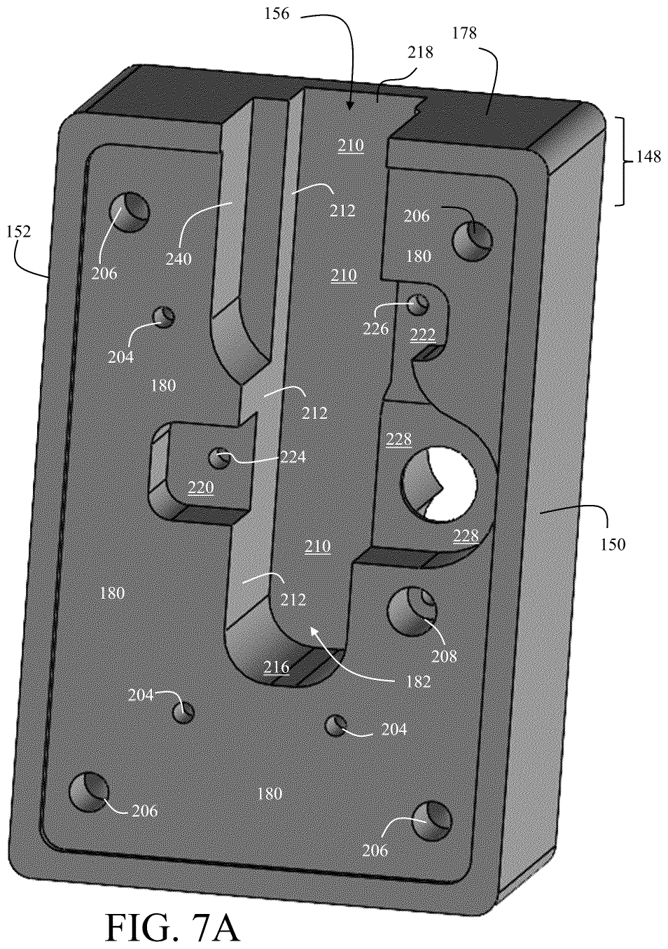

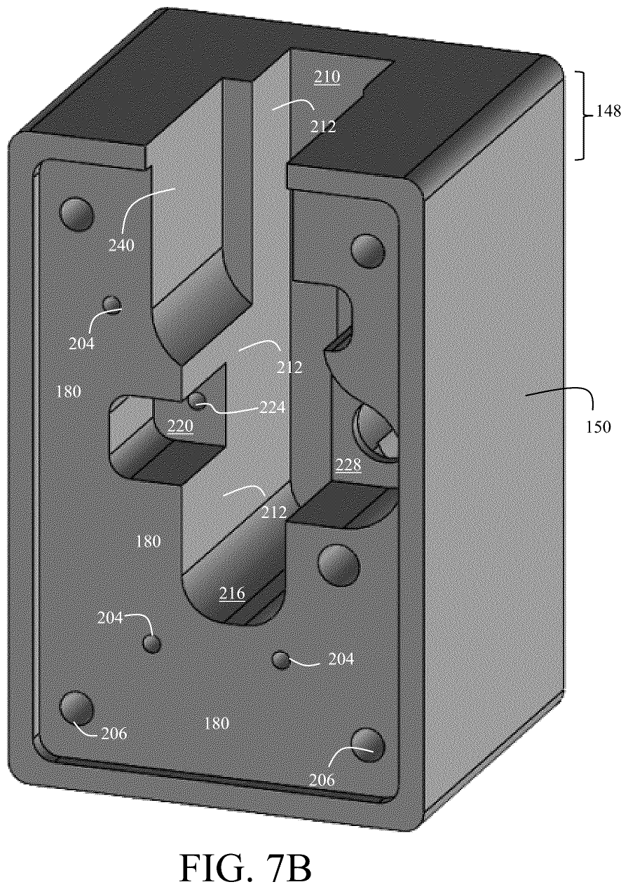

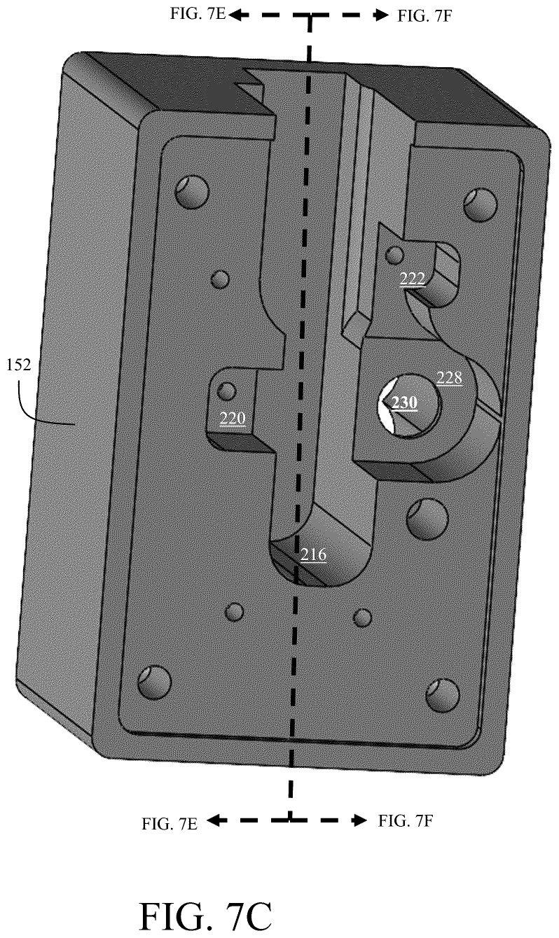

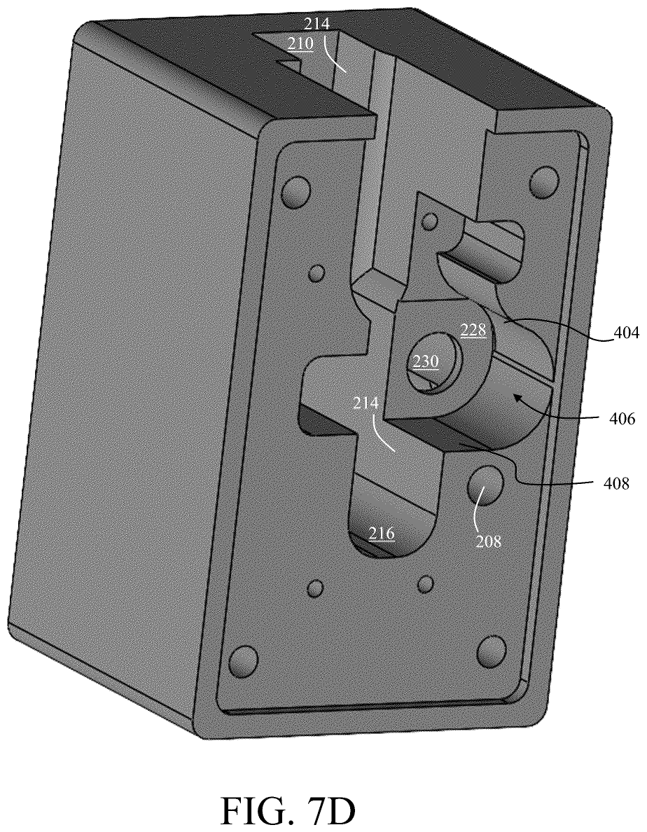

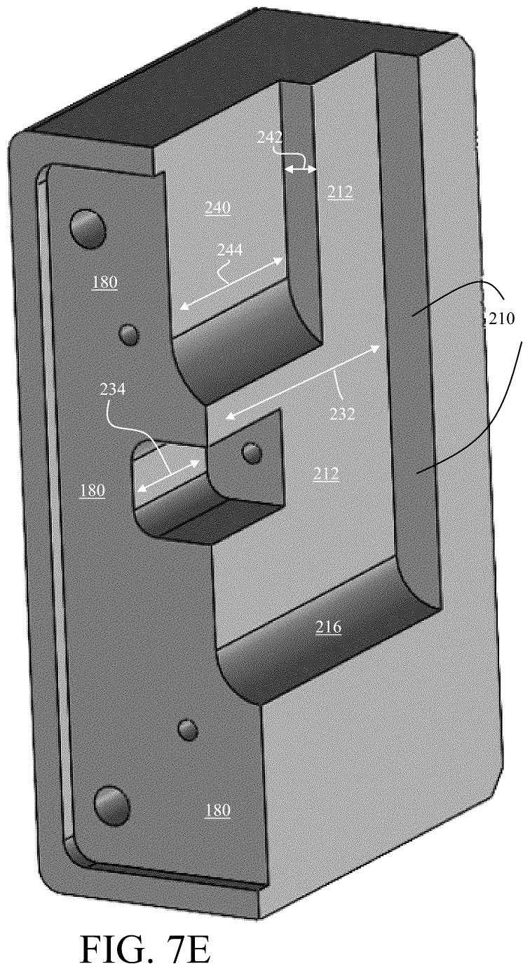

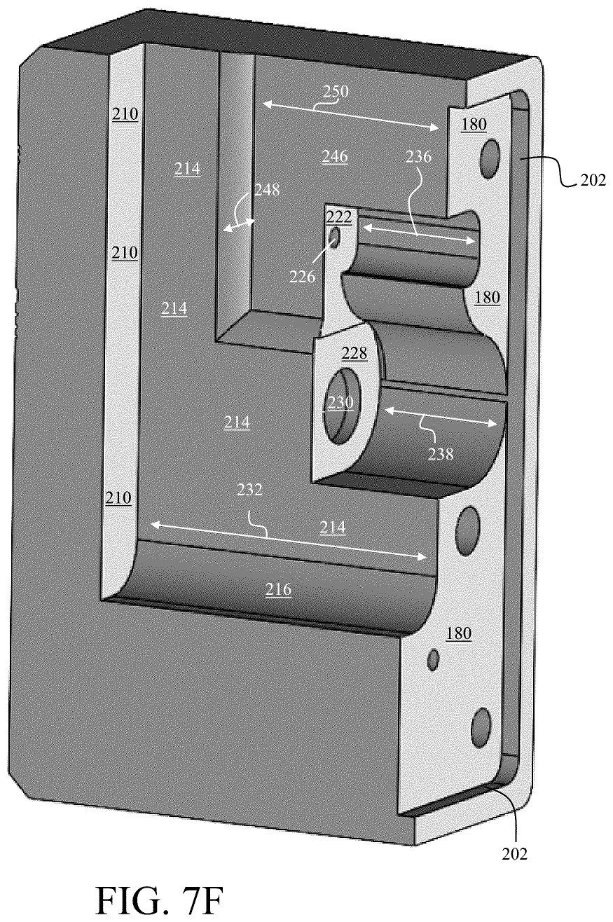

A bottom side 144 of main cover 124, the first shroud 138, the second shroud 140, and the third shroud 142 from a relief or cavity or recess 146 to receive and to cover upper most distal portions 148 (FIG. 7A) of a first lateral wall 150, a second lateral wall 152, and a front wall 154 of the protective casing 104, with main cover 124 covering a top opening 156 of protective lock case 104 when in locked position to prevent tampering.

Lateral relief-cuts 158 are provided between lateral distal ends of the third shroud 142 and exposed distal ends of the first and second shrouds 138 and 140 to allow for the formation of the shrouds.

As further illustrated, striker 114 of striker member 102 may include a free end 160 that engages the catch 256. Striker 114 further includes a body 162 and a free end 160. Body 162 of striker 114 has sufficient extent 164 and free end 160 has sufficient reach 166 to strike and be received within catch opening 256.

Striker 114 includes connecting end 168 that is integral with a rear side 170 of a main cover 124 of the protective shroud cover 112. Striker 114 is cantilevered from rear side 170 of main cover 124 of protective shroud cover 112, forming a striker general configured “C” or a “hook” shape. The illustrated lateral reliefs 172 are provided between lateral sides 174 of connecting end 168 of striker 114 and rear side 170 of main cover 124 to allow for the formation of striker 114.

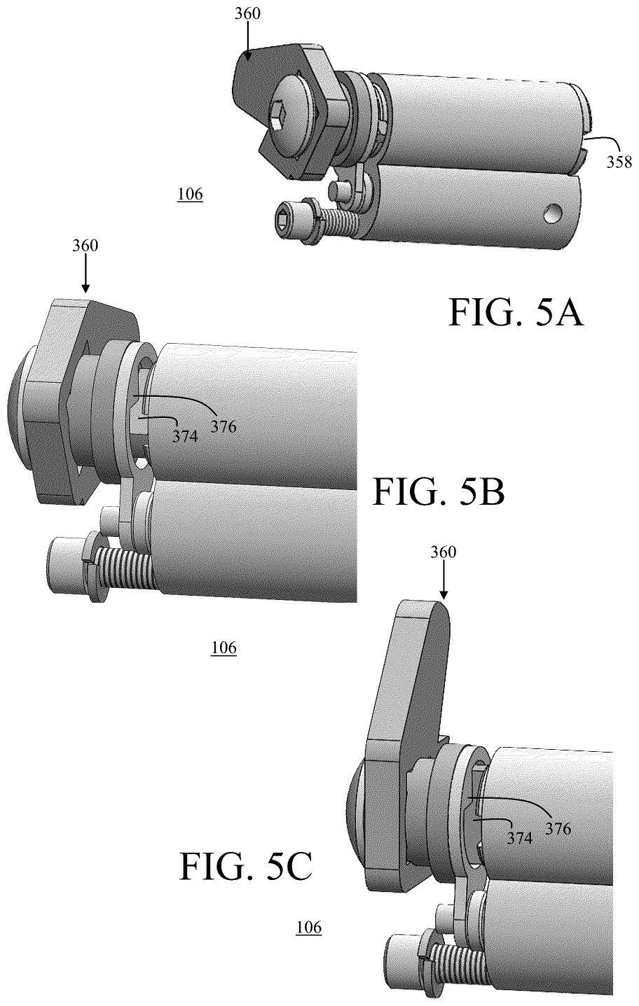

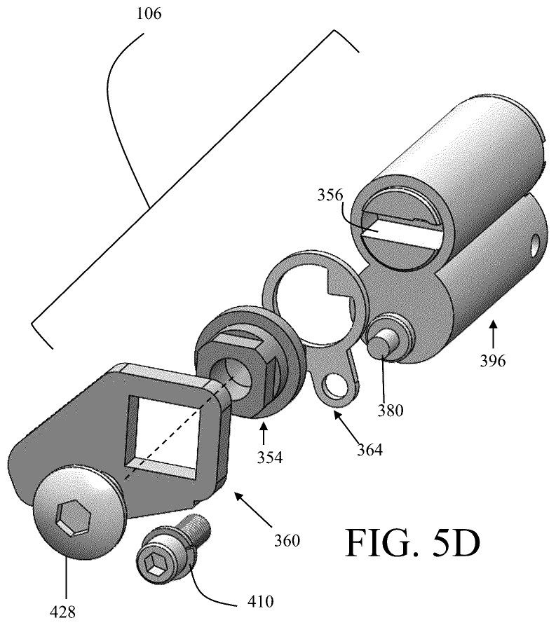

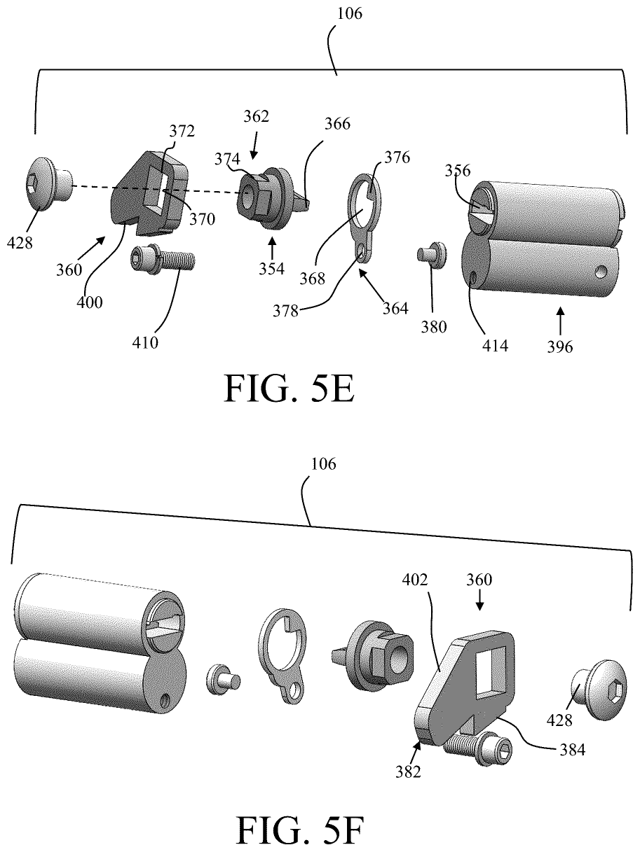

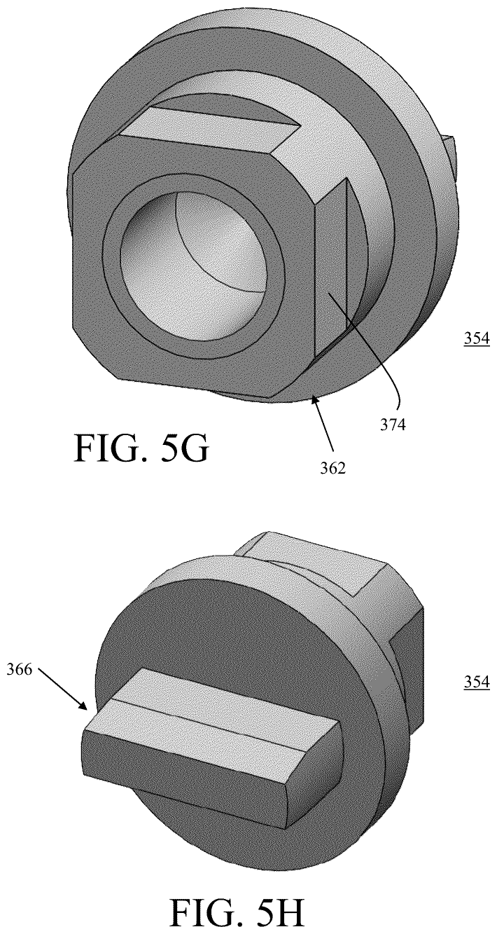

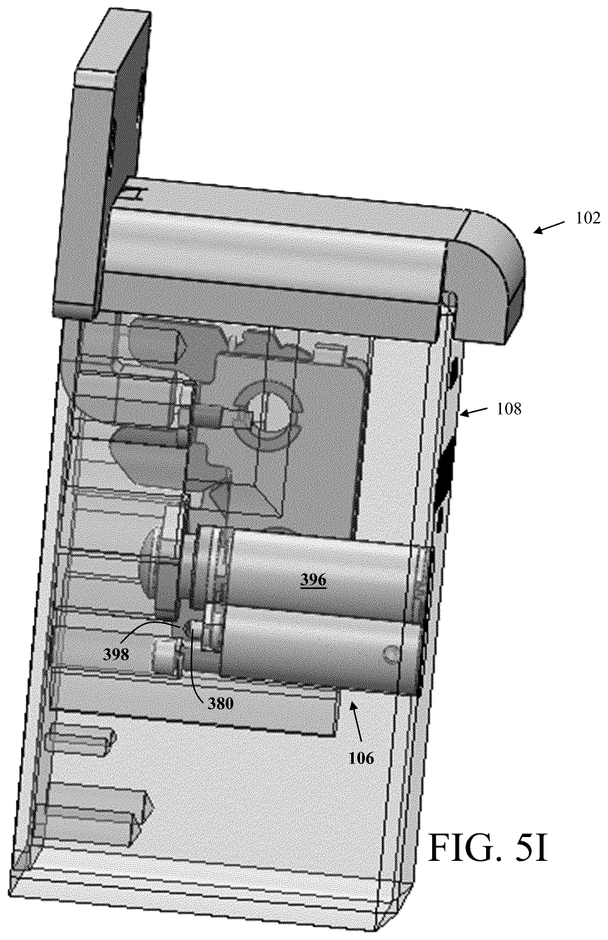

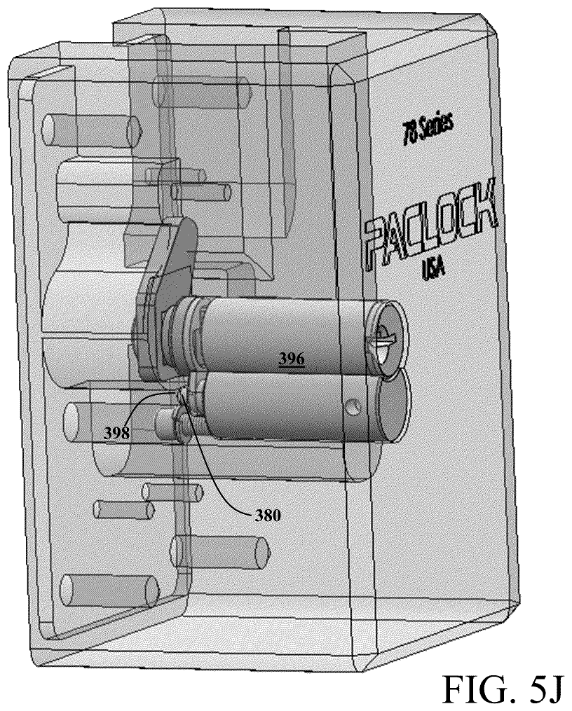

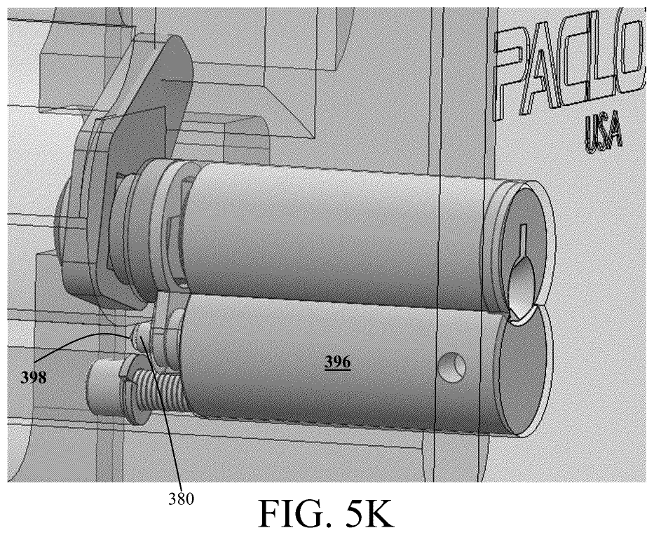

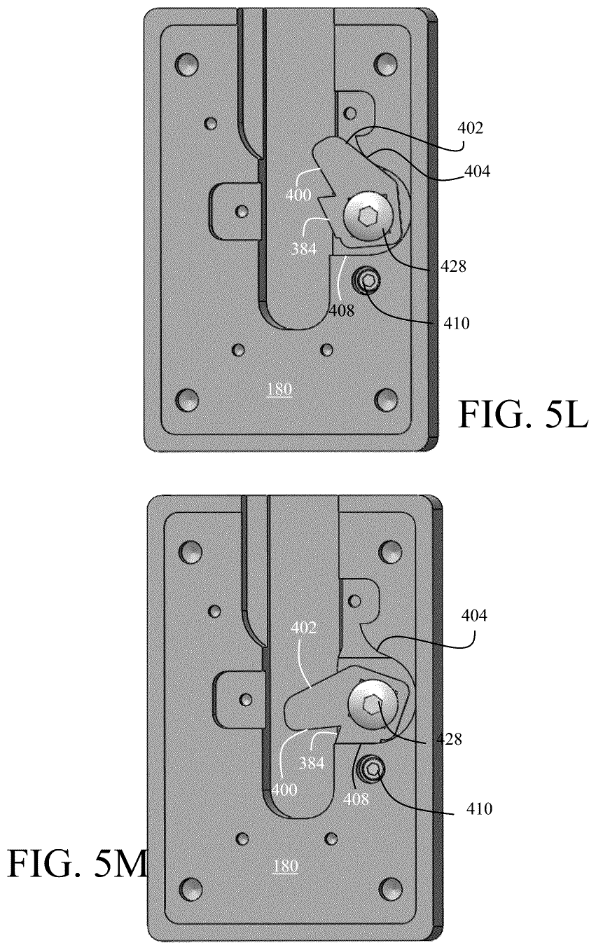

FIGS. 5A to 5M are non-limiting exemplary illustrations of the various views of a cylinder assembly of the lock device shown in FIGS. 1A to 4G in accordance with one or more embodiments of the present invention.

As illustrated in FIGS. 1A to 5M, cylinder assembly 106 may include a well-known cylinder 396, a driver member 354 that is mounted on a tail-end opening 356 of cylinder 396, opposite a key hole 358. Cylinder assembly 106 further includes an actuator cam 360 that is mounted on actuator side 362 the driver member 354.

The entire cylinder assembly 106 may be securely installed within protective lock casing 104 in a well-known conventional manner. Cylinder assembly 106 may be inserted to within protective lock casing from key cylinder openings 184, with the key hole 358 exposed. Fastener 410 may be used to secure cylinder assembly 106, which may be inserted through recessed opening 208 of protective lock casing 104, and fastened to securing opening 414 of cylinder 396.

A driver side 366 of the driver member 354 is inserted through stopper opening 368 of a stopper 364, and secured within the tail-end opening 356. Driver member 354 is comprised of driver side 366 configured commensurate with tail-end opening 356, and an actuator side 362 that includes an engagement end 374 configured commensurate with an inner periphery 372 of an engagement opening 370 of actuator cam 360.

Stopper 364 includes stopper opening 368 that has a stop 376 that extends within stopper opening 368, and a securing opening 378 that secures stopper 364 to interior, frontal facing opening 398 of protective lock casing 104 by a fastener 380. Driver side 366 of driver member 354 contacts stop 376 when cylinder 396 is rotated to extreme lock or unlock positions.

Actuator cam 360 of cylinder assembly 106 may be comprised of an engagement opening 370 with polygonal inner perimeter 372 for mounting actuator cam 360 onto engagement end 374 of actuator side 362 of driver member 354, with engagement end 374 of driver member 354 having a corresponding polygonal outer perimeter. This set up provides interlocking mating surfaces so that when driver member 354 is rotated, actuator cam 360 will also rotate accordingly. As further illustrated, actuator cam 360 may be secured to driver member 354 by a conventional fastener 428 such as one with threading or no threading such as a snap connection, friction-fit, press-fit (or interference fit), etc.

Actuator cam 360 of cylinder assembly 106 further includes a cam end 382 that when rotated to an unlock position, has a first edge 400 that engages a second edge 412 of lock member 258 of rotary latch 108 to move (e.g., rotate) lock member 258 from a lock position to an unlock position.

A second edge 402 of cam end 382 when in contact with a surface 404 of recess 406 of protective lock casing 104 prevent actuator cam 360 from over-rotating in one of a first or second rotations (best illustrated in FIG. 5L).

A stopper extension 384 of actuator cam 360 that when in contact with a surface 408 of recess 406 of protective lock casing 104 prevent actuator cam 360 from over-rotating in one of a second or first rotations (best illustrated in FIG. 5M).

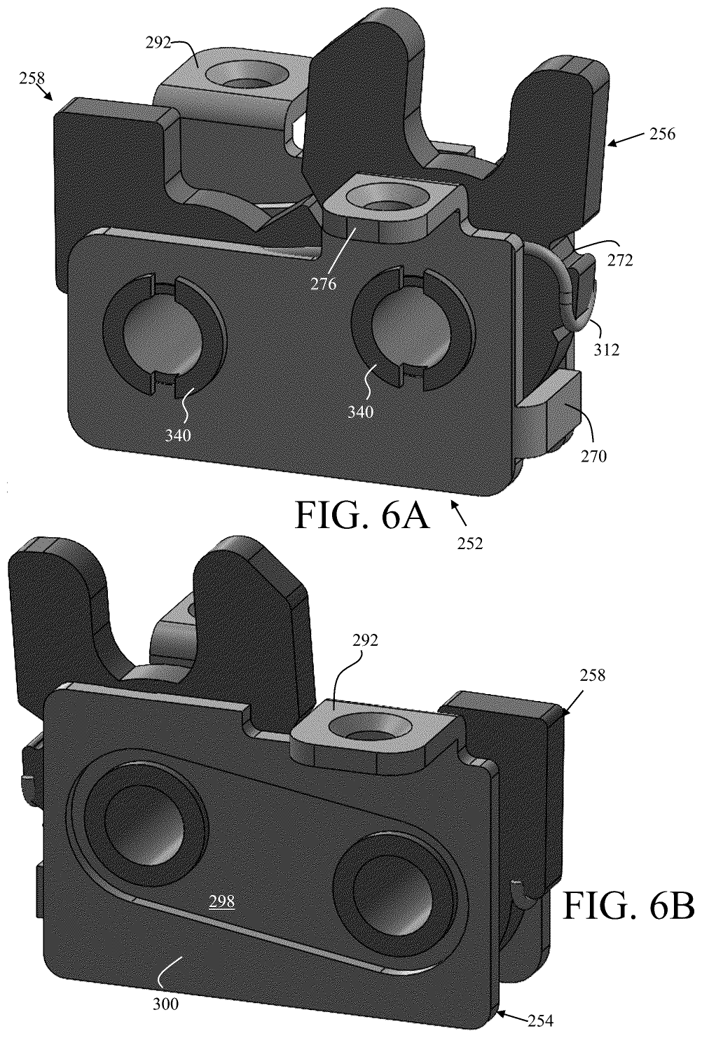

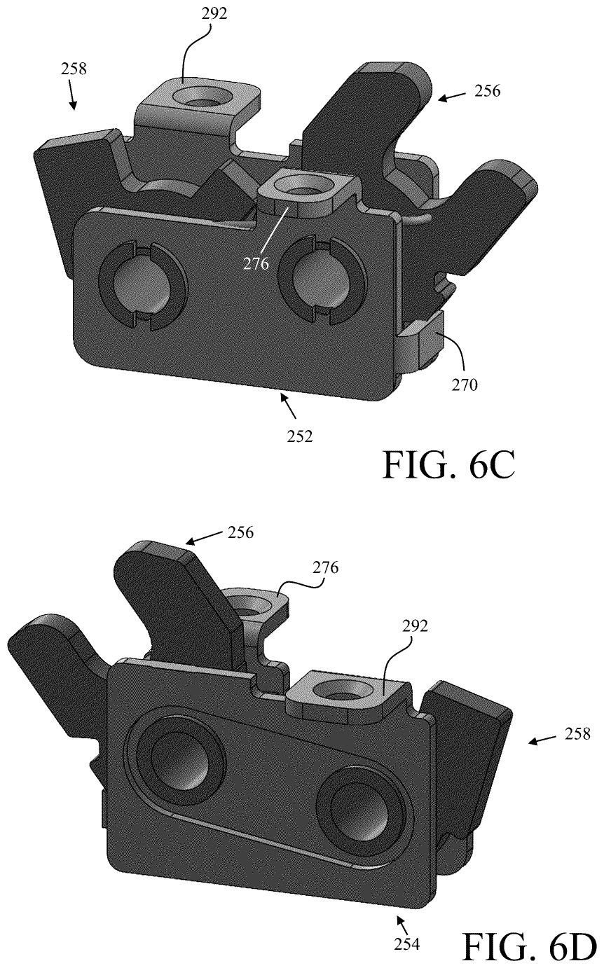

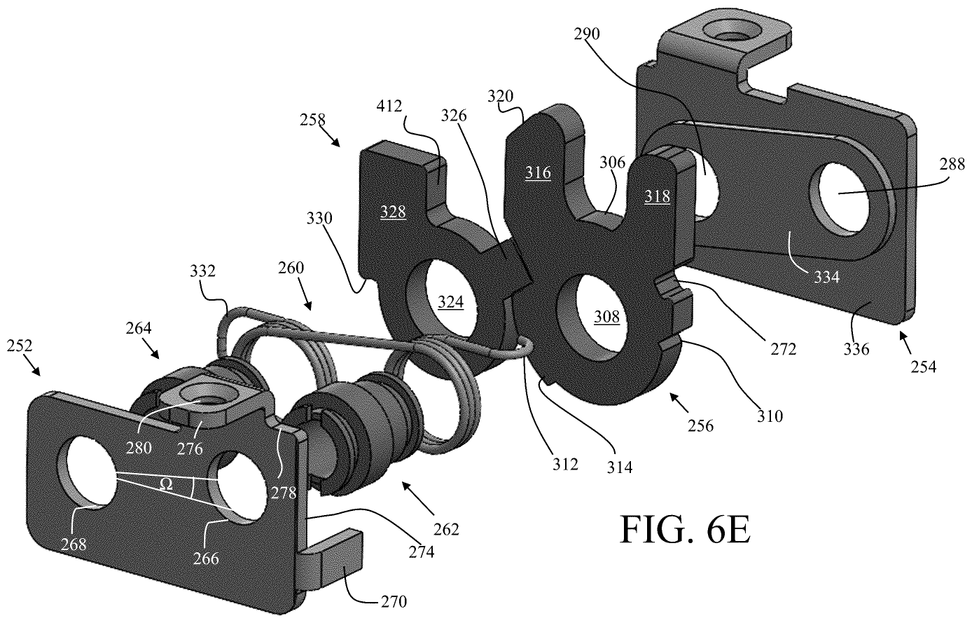

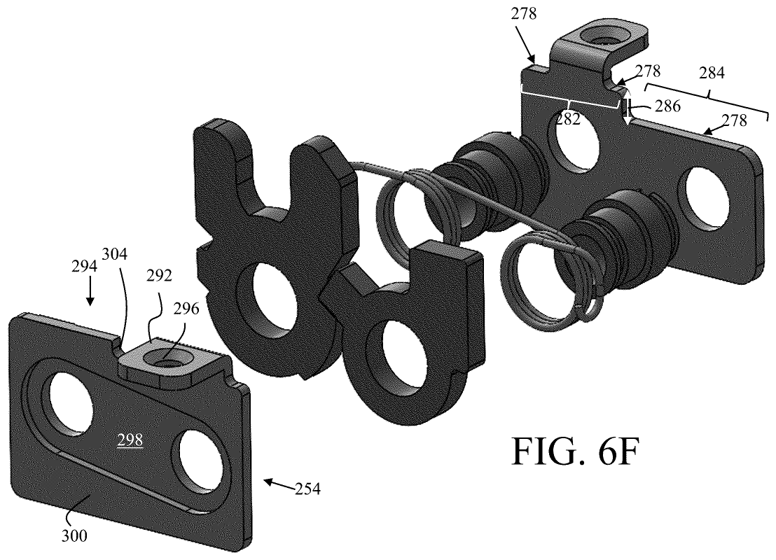

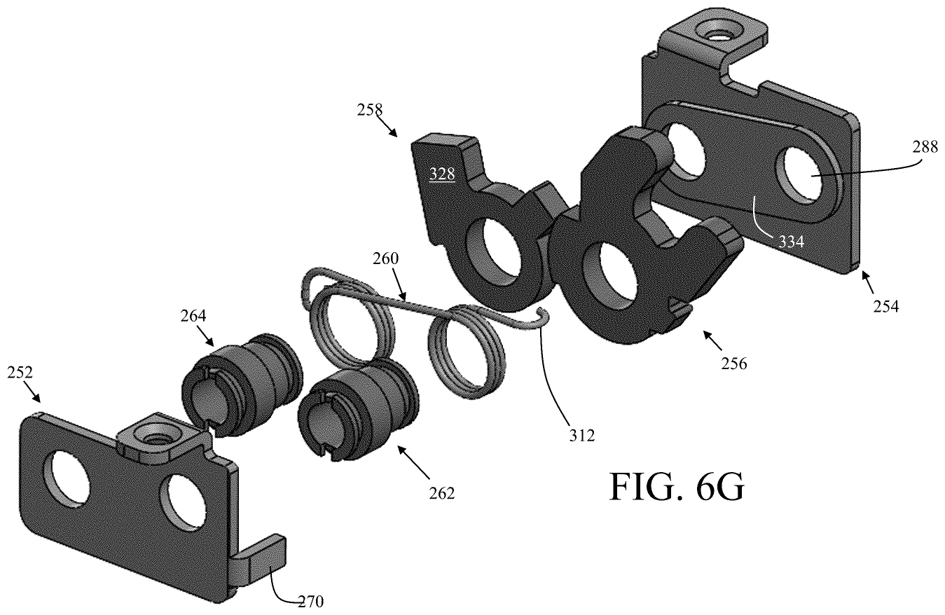

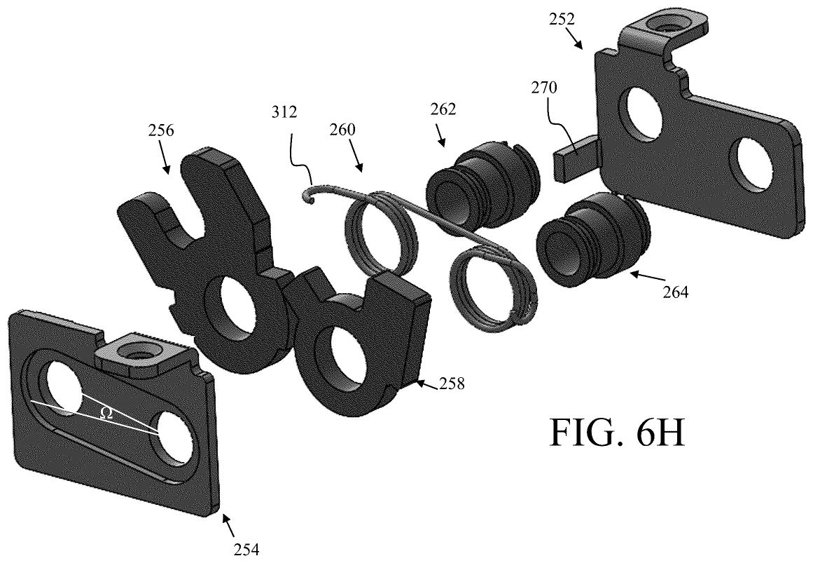

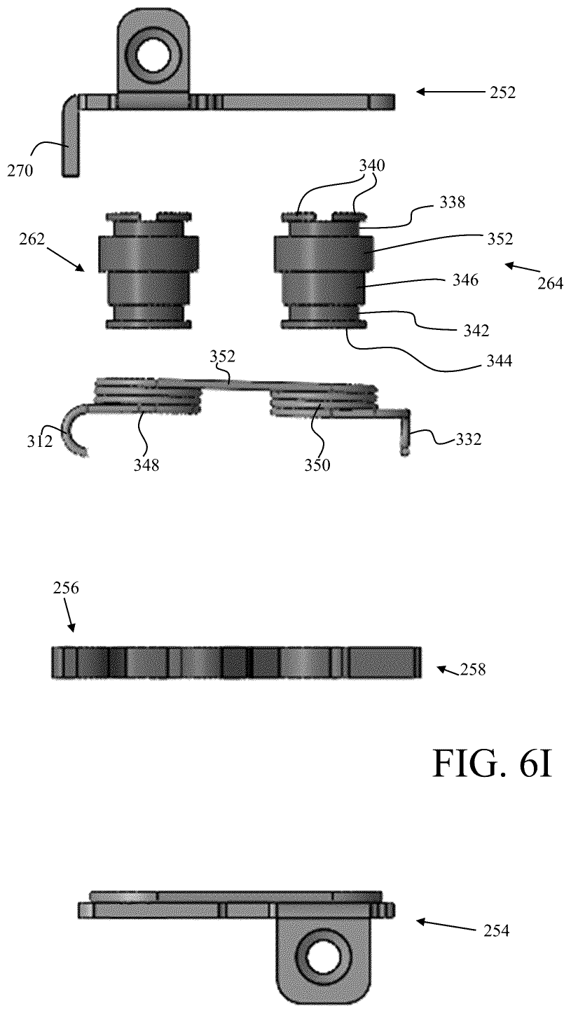

FIGS. 6A to 6I are non-limiting exemplary illustrations of the various views of a rotary latch of the lock device shown in FIGS. 1A to 5M in accordance with one or more embodiments of the present invention.

As illustrated in FIGS. 1A to 6I, rotary latch 108 may be comprised of a first support plate 252 and a second support plate 254. First support plate 252 and second support plate 254 secure the various components of rotary latch 108.

Rotary latch 108 further includes a catch 256 mounted on catch support shaft bushing 262 and a lock member 258 mounted on a lock member support shaft bushing 264. Further included is a resilient member 260 mounted on both the catch support shaft bushing 262 and the lock member support shaft bushing 264.

First support plate 252 may be comprised of a first plate opening 266 that receives the catch support shaft bushing 262, and a second plate opening 268 that receives the lock member support shaft bushing 264. As illustrated, a first center of first plate opening 266 is at an angle (2 with a second center of second plate opening 268. This non-alignment positions catch 256 closer to rear protective closure 186 and away from front wall 154 of protective lock casing 104 to allow for engagement reach 166 of striker 114 with catch 256.

First support plate 252 may further include a projection 270 that extends perpendicularly to a plane of first support plate 252 from a first side 274 of first support plate 252, towards second support plate 254. Projection 270 when engaged with a stop-recess 272 of catch 256 functions as a stop to prevent catch 256 from over rotating when in (or moving towards) unlatched position.

First support plate 252 may further be comprised of a first bracket 276 that extends perpendicularly to a plane of first support plate 252 from a first portion 282 of a second side 278 of first support plate 252, away from the second support plate 254. First bracket 276 includes a first securing opening 280 that receives a fastener to secure first support plate 252 to a second securing blind-hole 226 within a third recessed surface 222 of the protective casing 104.

First portion 282 of second side 278 of first support plate 252 is at a higher elevation 286 than a second portion 284 of second side 278. The higher elevated first portion 282 enables full reach of the first bracket 276 within third recessed surface 222 of the protective casing 104, while the lower elevated section portion 284 forms a first plate relief to allow for the proper operation of actuator cam 360.

Second support plate 254 of rotary latch 108 may be comprised of a first plate opening 288 that receives the catch support shaft bushing 262 and a second plate opening 290 that receives the lock member support shaft bushing 264.

A first center of first plate opening 288 at an angle 22 with a second center of second plate opening 290, which allows for positioning catch 256 closer to rear protective closure 186 and away from front wall 154 of protective lock casing 104 to allow for engagement reach 166 of striker 114 with catch 256.

Second support plate 254 may be further comprised of a second bracket 292 that extends perpendicular a plane of second support plate 254 of a first side 294 of second support plate 254, away from first support plate 252.

Second bracket 292 includes a securing opening 296 that receives a fastener to secure second support plate 254 to a first securing blind-hole 224 within a second recessed surface 220 of protective lock casing 104.

Second support plate 254 is further comprised of a recessed section 298 at an exterior 300, defining a projected section 334 at an interior side 336, with projected section 334 functioning as a washer while recessed section 298 allowing flanges 344 to be flush with exterior 300. First side 294 includes recess 304 for reliefs to allow for bending the bracket 292.

Catch 256 of rotary latch 108 may be comprised of a first and a second tines 316 and 318 with a slot 306 that receiver striker 114. First tine 316 includes an exterior chamfered surface 320 that functions as a relief to clear a bottom edge 322 of relief 200 of rear protective enclosure 186 when catch 256 is in latched position.

Catch 256 further includes a mounting opening 308 for mounting catch 256 onto catch support shaft bushing 262. Further included are a circumferentially positioned stop-recess 272, and a circumferentially positioned securing-recess 310 for securing a catch-end 312 of a resilient member 260, and a circumferentially positioned mating lock projection 314.

Lock member 258 of rotary latch 108 may be comprised of a mounting opening 324 for mounting lock member 258 onto lock member support shaft bushing 264. Further included are a circumferentially positioned lock projection 326, and a circumferentially positioned projection 328, a first edge 330 of which secures a lock member end 332 of a resilient member 260. A second edge 412 of lock member 258 engages with a first edge 400 of actuator cam 360, allowing first edge 400 to move (e.g., rotate) lock member 258 from a lock position to an unlock position.

Catch support shaft bushing 262 and the lock member support shaft bushing 264 of rotary latch 108 are identical, and may be comprised of hollow cylinders having an exterior surface comprised of a first circumferential surface 352 with the longest outer diameter, forming the bulk or strength of the shafts.

Further included is a first circumferential plate engagement recess 338 that mounts onto first and second plate openings 266 and 268 of first support plate 252, and are secured onto first support plate 252 by a first distal end flange 340.

Further included is a second circumferential plate engagement recess 342 that mounts onto first and second plate openings 288 and 290 of second support plate 254, and are secured onto second support plate 254 by a second distal end flange 344. It should be noted that flanges 344 are configured as continuous annular flanges whereas flanges 340 are comprised of two semi-circle flanges, which allow for proper mounting or assembly orientation of catch support shaft bushing 262 and lock member support shaft bushing 264 in relation to plates 252 and 254. A circumferential resilient member recess 346 houses coil sections 348/350 of resilient member 260.

Resilient member 260 of rotary latch is comprised of an inline dual coil spring having a catch-end 312, a first coil section 348, a second coil section 350 connected to the first coil section 348 by a linear bridge 352, and a lock member end 332.

FIGS. 7A to 7F are non-limiting exemplary illustrations of the various views of a protective lock casing of the lock device shown in FIGS. 1A to 6I in accordance with one or more embodiments of the present invention.

As illustrated in FIGS. 1A to 7F, protective lock casing 104 may be comprised of a first lateral protective wall 150 and a second lateral protective wall 152. Protective lock casing 104 further includes a bottom protective side 176 and a front protective wall 154. Protective lock casing further includes a top protective side 178 with a top side opening 156, and a back protective side 180 with a back opening 182.

Front protective wall 154 includes a through-opening 184 for housing a cylinder assembly 106. Top side opening 156 allows striker 114 to engage with catch 256 of rotary latch 108. Top side opening 156 is fully covered and protected by protective shroud cover 112 of striker member 102 when in closed position.

Back opening 156 allows for installing of rotary latch 108 within the protective lock casing 104, and is fully covered and protected by rear protective enclosure 186.

Back protective side 180 is recessed, formed from extended periphery edges 202 of first lateral protective wall 150, second lateral protective wall 152, bottom protective side 176, and top protective side 178, allowing for rear protective enclosure 186 to be flush with protective lock casing 104 when fully assembled.

Back protective side 180 is comprised of a first set of openings 204 that correspond with first set of openings 188 of rear protective enclosure (or plate) 186 to secure rear protective enclosure 186 to protective lock casing 104 using fasteners 190.

Back protective side 180 further includes a second set of openings 206 that correspond with a second set of openings 192 of rear protective enclosure 186 to secure protective lock casing 104 of lock device 100 to an exterior side of a container 194 using fasteners. 198.

Back protective side 180 further includes one or more third openings 208 that correspond with one or more third openings 196 of rear protective enclosure 186 to secure one or more components (e.g., cylinder assembly 106) of lock device 100 within protective lock casing 104.

Back opening 182 of back protective side 180 of protective lock casing 104 is comprised of a first recessed surface 210 that is recessed at a first depth 232 from the back protective side 180, which is comprised of first and second lateral walls 212 and 214, and a bottom wall 216, with top distal end 218 of the first surface 210 open.

Back opening 182 further includes a second recessed surface 220 and a third recessed surface 222 that are recessed at respective second and third depths 234 and 236 from the back protective side 180 include respective first and second securing blind-holes 224 and 226.

Back opening 182 also includes a fourth recessed surface 228 that is recessed 406 at fourth depth 238 from the back protective side 180 includes a through-opening 230.

Back opening 182 additionally includes a fifth recessed surface 240 that is laterally recessed at a first lateral depth 242 from the first lateral wall 212 of the first surface 210, and at a fifth depth 244 from the back protective side 180.

Back opening 182 further includes a sixth recessed surface 246 that is laterally recessed at a second lateral depth 248 from the second lateral wall 214 of the first surface, and at a sixth depth 250 from the back protective side 180.

Fifth recessed surface 240 and the sixth recessed surface 246 are laterally recessed, which provide sufficient size to allow and accommodate for the free movement of catch 256 in addition to free and unhindered movement of striker 114 within protective lock casing 104. Additionally, as detailed above, the fourth recessed surface 228 has sufficient size to allow for free movement of actuator cam 260.

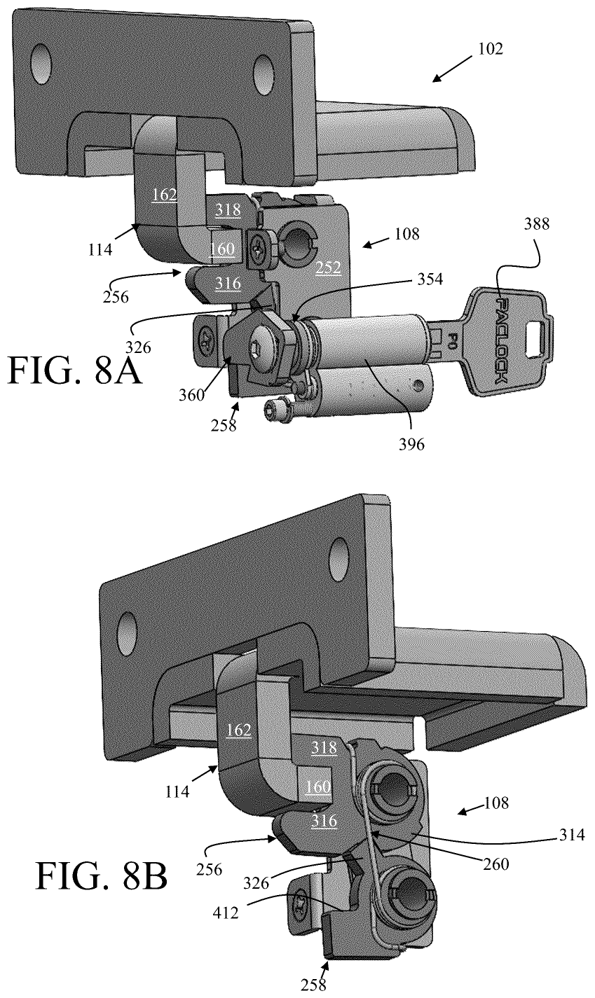

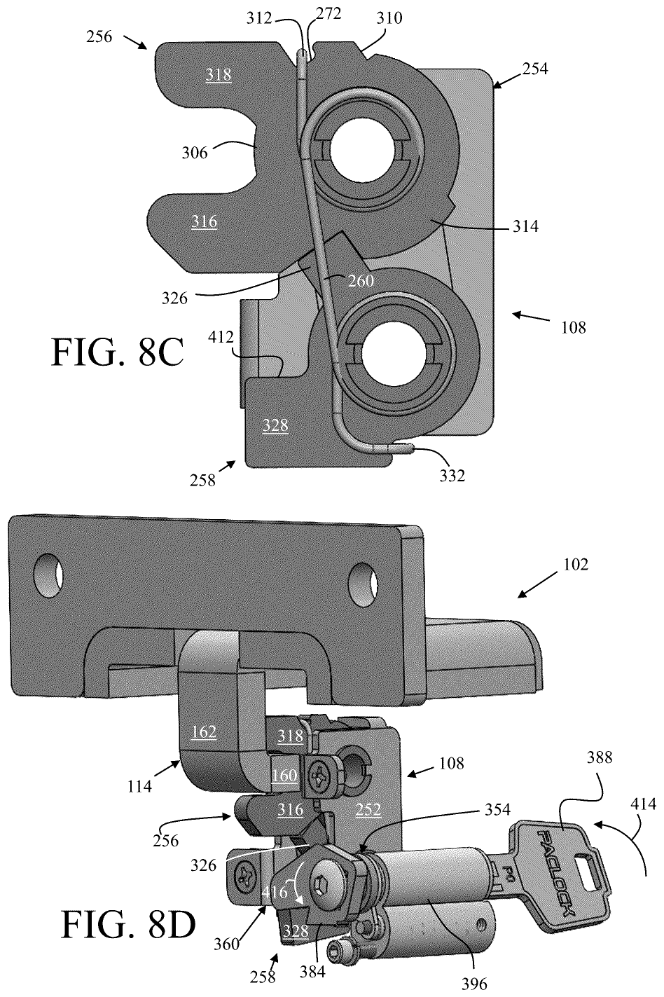

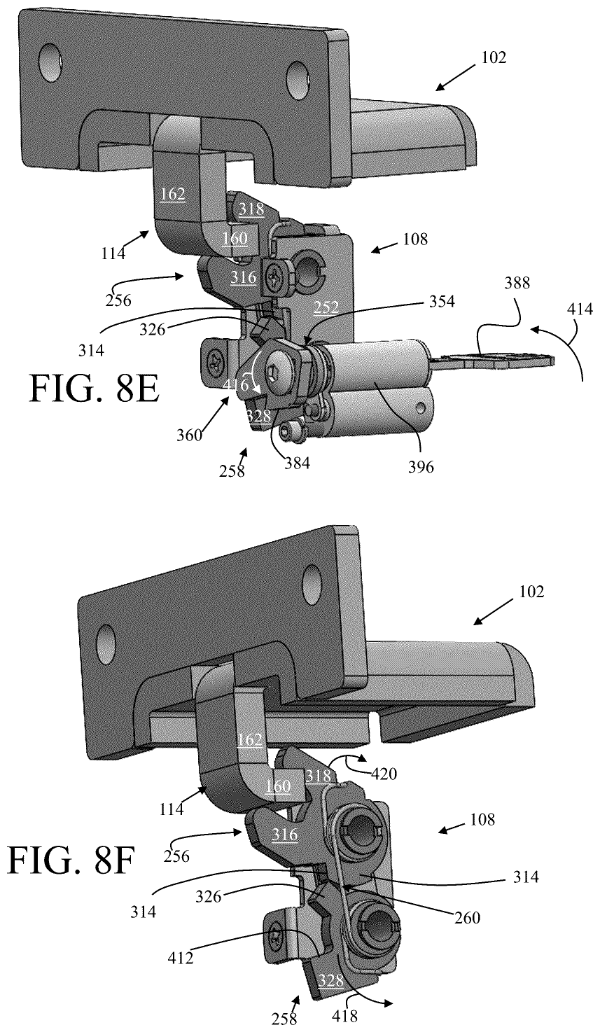

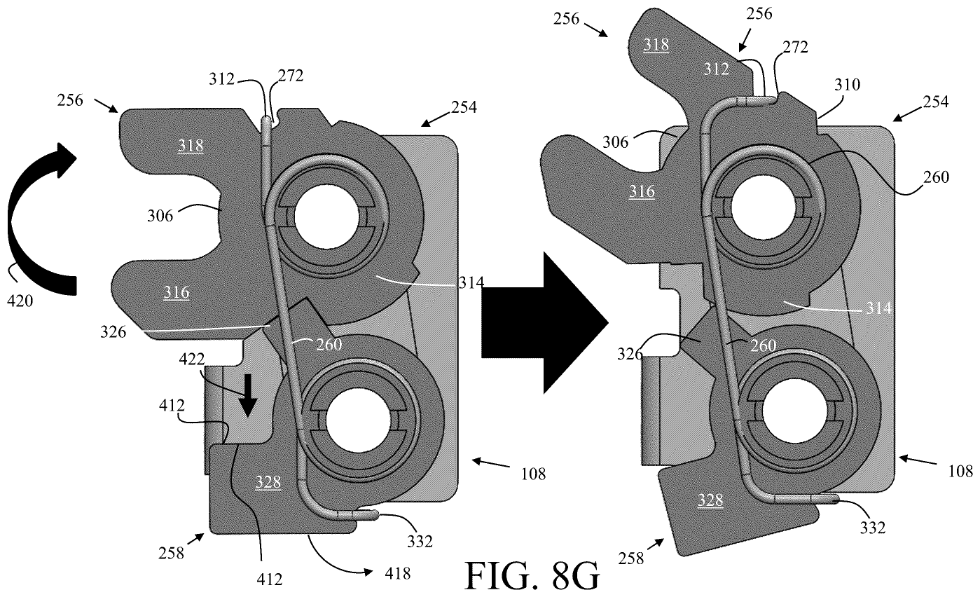

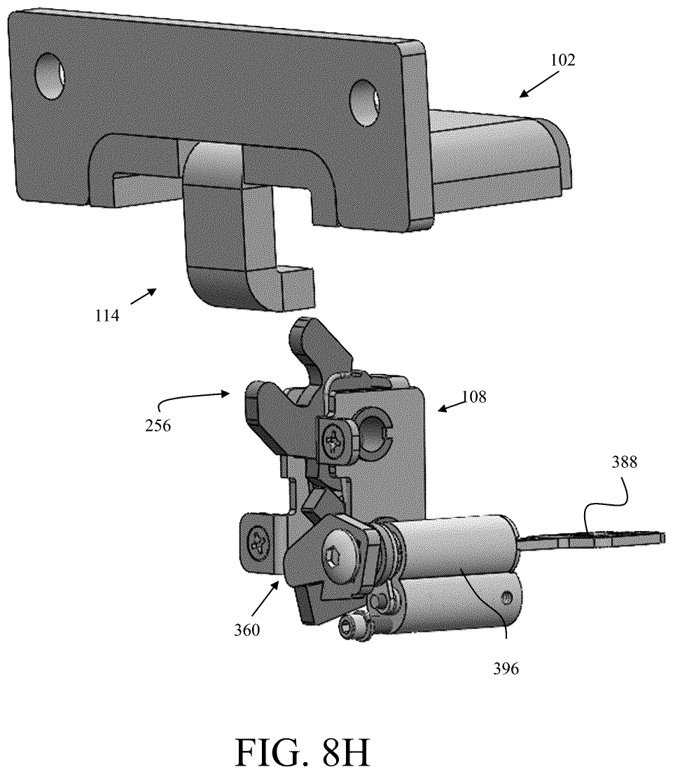

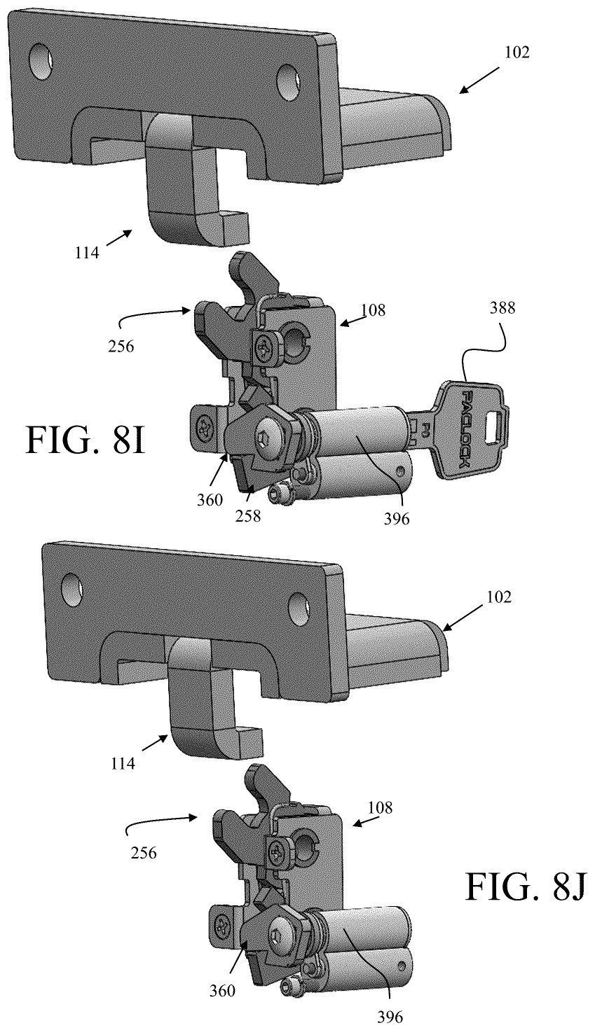

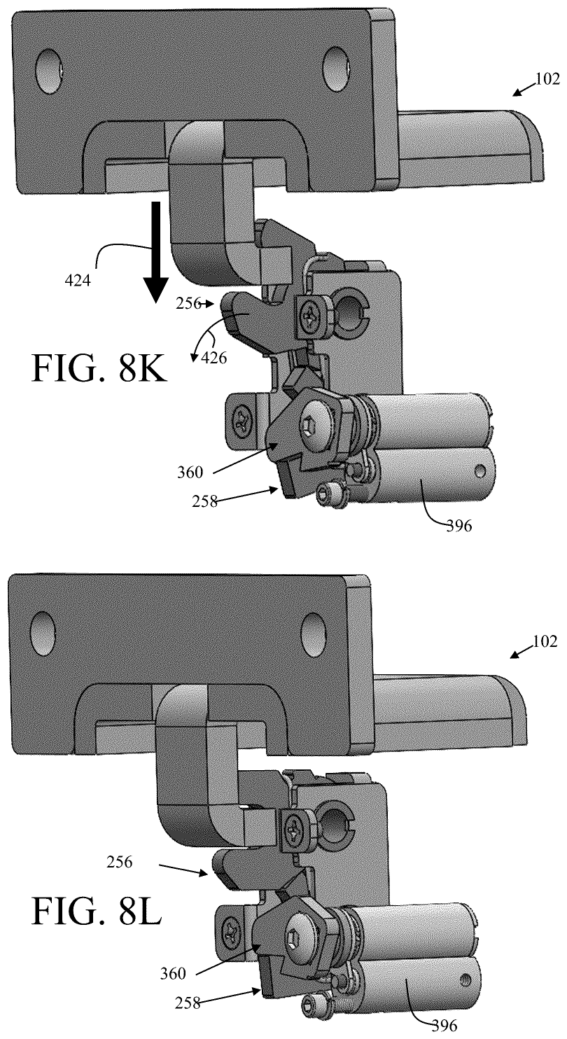

FIGS. 8A to 8L are non-limiting exemplary illustrations of the various views of the exposed parts of the lock device shown in FIGS. 1A to 7F, progressively illustrating a non-limiting, exemplary method of operation of the lock device components in accordance with one or more embodiments of the present invention.

FIGS. 8A to 8C, illustrate lock device 100 in a fully locked position with FIG. 8A illustrating an inserted key 388 into cylinder 396. Free end 160 of striker 114 is fully interlocked within recess or opening 306 of catch 256 of rotary latch 108.

As illustrated in FIGS. 8B and 8C (with first support plate 252 removed), lock projection 326 of lock member 258 is engaged with mating lock projection 314 of catch 256 when both lock member 258 and catch 256 are in latched position. Stated otherwise, lock projection 326 when engaged with mating lock projection 314 prevent and blocks movement of catch 256, maintaining catch 256 in locked position.

The default rest (or equilibrium or unloaded) position of resilient member 260 is when rotary latch 108 is at an unlatched position. Accordingly, the locked position shown in FIGS. 8A to 8C illustrates resilient member 260 as loaded.

FIGS. 8D to 8G progressively illustrate lock device 100 in the process of being unlocked as key 388 is rotated. Rotating key 388 (shown by arrow 414) rotates driver member 354 to rotate 416 actuator member 360.

Rotation 416 of actuator member 360 allows a first edge 400 of actuator member 360 to engage second edge 412 of lock member 258 and apply a force 422 to rotate 418 lock member 258 from a lock position to an unlock position.

As indicated above, the final rotational unlock position of actuator member 360 is dictated by stopper extension 384 of actuator cam 360 in contact with surface 408 of recess 406 of protective lock casing 104, which would prevent actuator cam 360 from over-rotating.

As illustrated in FIGS. 8F and 8G, rotation 418 of lock member 258 disengages lock projection 326 from mating lock projection 314 to free catch 256. Resilient member 260 associated with lock member 258 and catch 256 is also now free to move to release stored energy and move from a loaded position to an unloaded position.

FIGS. 8H to 8J illustrate lock device 100 in a fully unlocked position. As illustrated, key 388 may be removed when it is rotated back to original position (as with most conventional key cylinder operations). Rotating key 388 back to original position (FIG. 81) would also rotate actuator cam 360 back to its original position while lock member 258 and catch 256 continue to remain in their unlatched positions.

It should be noted that when lock member 258 is rotated 418 from latched to unlatched position, applied force from lock member 258 and catch 258 acting on resilient member 260 to maintain it in a loaded position is removed, allowing resilient member 260 to move from a loaded position to an unloaded position and releasing stored energy. The movement of resilient member 260 to an unloaded position releases stored energy, which is applied to catch 256 to move catch 256 to an unlatched position, thus releasing strike member 102 and allowing the lid to “pop” open.

As best illustrated in FIGS. 8K and 8L, when lid 118 is closed, force 424 exerted by striker 114 of strike member 102 connected with lid 118 moves catch 256 along direction 426 to a latched position, thus loading resilient member 260, which, in turn, moves lock member 258 into latched position, locking lock device 100 without the use of any key.

Although the invention has been described in considerable detail in language specific to structural features and or method acts, it is to be understood that the invention defined in the appended claims is not necessarily limited to the specific features or acts described. Rather, the specific features and acts are disclosed as exemplary preferred forms of implementing the claimed invention. Stated otherwise, it is to be understood that the phraseology and terminology employed herein, as well as the abstract, are for the purpose of description and should not be regarded as limiting. Further, the specification is not confined to the disclosed embodiments. Therefore, while exemplary illustrative embodiments of the invention have been described, numerous variations and alternative embodiments will occur to those skilled in the art. For example, cylinder assembly 106 and physical key 388 may easily be replaced by well-known remote, wireless or key-less based systems. Such variations and alternate embodiments are contemplated and can be made without departing from the spirit and scope of the invention.

It should further be noted that throughout the entire disclosure, the labels such as left, right, front, back, top, inside, outside, bottom, forward, reverse, clockwise, counter clockwise, up, down, or other similar terms such as upper, lower, aft, fore, vertical, horizontal, lateral, oblique, proximal, distal, parallel, perpendicular, transverse, longitudinal, etc. have been used for convenience purposes only and are not intended to imply any particular fixed direction, orientation, or position. Instead, they are used to reflect relative locations/positions and/or directions/orientations between various portions of an object.

In addition, reference to “first,” “second,” “third,” and etc. members throughout the disclosure (and in particular, claims) is not used to show a serial or numerical limitation but instead is used to distinguish or identify the various members of the group.

Further the terms “a” and “an” throughout the disclosure (and in particular, claims) do not denote a limitation of quantity, but rather denote the presence of at least one of the referenced item.

The use of the phrases “and or,” “and/or” throughout the specification (if any used) indicate an inclusive “or” where for example, A and or B should be interpreted as “A,” “B,” or both “A and B.”

In addition, any element in a claim that does not explicitly state “means for” performing a specified function, or “step for” performing a specific function, is not to be interpreted as a “means” or “step” clause as specified in 35 U.S.C. Section 112f. In particular, the use of “step of,” “act of,” “operation of,” or “operational act of” in the claims herein is not intended to invoke the provisions of 35 U.S.C. 112f.

What is claimed is:

1. A lock device for a container, comprising:
a striker member fixed external a lid of the container;
a protective lock casing fixed external the container;
the protective lock casing houses:
a cylinder assembly; and
a rotary latch;
the rotary latch is actuated from a latched position to an unlatched position for unlocking the lock device, and is actuated from an unlatched position to a latched position by the striker member when engaged with the rotary latch for locking the lock device.

2. The lock device for a container as set forth in claim 1, wherein:
the container is a truck tool box.

3. The lock device for a container as set forth in claim 1, wherein:
the cylinder assembly includes an actuator cam that rotates to actuate a catch of the rotatory latch from the latched position to the unlatched position, thus releasing the strike member.

4. The lock device for a container as set forth in claim 1, wherein:
the actuation of the catch of the rotatory latch from the latched position to the unlatched position allows a resilient member of the rotary latch to change from a loaded state with a stored positive potential energy to an unloaded state with positive kinetic energy, which is applied to the catch to move the catch to an unlatched position and quickly release the strike member, thus allowing the lid to pop open.

5. The lock device for a container as set forth in claim 1, wherein:
the striker member includes a protective shroud cover that fully covers over and protects an upper most distal portions of the protective lock casing.

6. The lock device for a container as set forth in claim 1, wherein:
the protective lock casing is comprised of a top opening for accommodating a striker of the striker member.

7. A lock device, comprising:
a striker member;
a protective lock casing that houses:
a cylinder assembly; and
a rotary latch;
the rotary latch is actuated from a latched position to an unlatched position for unlocking the lock device, and is actuated from an unlatched position to a latched position by the striker member when engaged with the rotary latch for locking the lock device.

8. The lock device as set forth in claim 7, wherein:
the striker member is comprised of:
a protective shroud cover.

9. The lock device as set forth in claim 7, wherein:
the protective lock casing is comprised of:
a top protective side with a top side opening that accommodates a striker of the striker member; and
a back protective side with a back opening for assembly of the rotary latch within the protective casing.

10. The lock device as set forth in claim 9, wherein:
top side opening of the top protective side of the protective lock casing is fully covered over and protected by a protective shroud cover of the striker member when in closed position.

11. The lock device as set forth in claim 9, wherein:
the back opening of the back protective side of the protective lock casing is fully covered and protected by a rear protective enclosure.

12. The lock device as set forth in claim 9, wherein:
the back opening of the back protective side of the protective lock casing is comprised of a plurality of recessed surfaces to accommodate the cylinder assembly and the rotary latch.

13. The lock device as set forth in claim 7, wherein:
the cylinder assembly includes:
a driver member; and
an actuator cam;
the driver member moves the actuator cam to engage a lock member of the rotary latch for unlatching the rotary latch.

14. A lock device for a truck tool box, comprising:
a striker member fixed external a lid of the truck tool box;
a protective lock casing fixed external the truck tool box;
the protective lock casing houses:
a cylinder assembly; and
a rotary latch;
the rotary latch is actuated from a latched position to an unlatched position for unlocking the lock device, and is actuated from an unlatched position to a latched position by the striker member when engaged with the rotary latch for locking the lock device.

15. The lock device for a truck tool box as set forth in claim 14, wherein:
the cylinder assembly includes an actuator cam that rotates to actuate a catch of the rotatory latch from the latched position to the unlatched position, thus releasing the strike member.

16. The lock device for a truck tool box as set forth in claim 14, wherein:
the actuation of the catch of the rotatory latch from the latched position to the unlatched position allows a resilient member of the rotary latch to change from a loaded state with a stored positive potential energy to an unloaded state with positive kinetic energy, which is applied to the catch to move the catch to an unlatched position and quickly release the strike member, thus allowing the lid to pop open.

17. The lock device for a truck tool box as set forth in claim 14, wherein:
the striker member includes a protective shroud cover that fully covers over and protects an upper most distal portions of the protective lock casing.

18. The lock device for a truck tool box as set forth in claim 14, wherein:
the protective lock casing is comprised of a top opening for accommodating a striker of the striker member.

19. The lock device for a truck tool box as set forth in claim 14, wherein:
the cylinder assembly includes:
an actuator cam that engages the rotary latch for unlatching the rotary latch.

20. The lock device for a truck tool box as set forth in claim 14, wherein:
the striker member is fixed external the lid of the truck tool box by a first set of fasteners; and
the protective lock casing is fixed external the truck tool box by a second set of fasteners.
